(19) United States
(12) Patent Application Publication
(10) Pub. No.: US 2020/0298236 A1
(43) Pub. Date: Sep. 24, 2020

(54) FLUIDIC APPARATUS AND METHOD

(71) Applicants: Cambridge Enterprise Limited, Cambridge (GB); Fluidic Analytics Limited, Cambridge (GB)

(72) Inventors: Tuomas Pertti Jonathan Knowles, Cambridge (GB); Kadi Liis Saar, Cambridge (GB); Tadas Kartanas, Cambridge (GB); Thomas Mueller, Cambridge (GB)

(73) Assignees: Cambridge Enterprise Limited, Cambridge (GB); Fluidic Analytics Limited, Cambridge (GB)

(21) Appl. No.: 16/771,054

(22) PCT Filed: Dec. 11, 2018
(86) PCT No.: PCT/GB2018/053583

§ 371 Date: Jun. 9, 2020

(30) Foreign Application Priority Data
Dec. 11, 2017 (GB) 1720627.7

(51) Int. Cl. B01L 3/00

(52) U.S. Cl. CPC B01L 3/502776; B01L 2200/0636; B01L 2400/0421; B01L 2300/0816; B01L 2300/0867; B01L 2200/027

(57) ABSTRACT

A fluidic device is provided. The fluidic device comprises a separation channel having at its upstream end a junction, a first channel for supplying a first fluid flow, a second channel for supplying a second fluid flow. The first and second channels meet at the junction are adapted to provide the first fluid flow in the separation channel sheathed by the second fluid flow, such that the first fluid flow does not contact the separation channel walls. The separation channel, the first and second channels are provided as a unitary piece, or where the separation channel and the first and second channels are provided as a non-unitary piece comprising a plurality of parts, the parts are of the same material.

### FIELD OF THE INVENTION

The present invention provides a fluidic device, such as a microfluidic device, for use in methods of separation and methods for separating and collecting components, such as by phoresis, using the device.

The work leading to this invention has received funding from the European Union's Seventh Framework Programme (FP7/2007-2013) under ERC grant agreement No 337969.

### BACKGROUND

Free flow electrophoresis is a useful tool for the continuous separation of mixtures. A sample containing a mixture of components in a flow is exposed to a lateral electrical field, which affects a continuous separation of the components in the flow mixture according to their charge to radius ratio. Unlike other commonly used separation techniques, free flow electrophoresis is performed in the fluid phase and without the presence of any support matrix. This ensures that the separation occurs under native conditions and with a high recovery rate of the components.

Some of the present inventors have previously described the use of free flow electrophoresis in series with other free flow separation techniques, such as diffusion, for the characterisation and separation of component mixtures. See, for example, WO 2015/071683, where the electrophoretic separation of a component mixture, followed by collection of a part of the fluid stream which contains a component of interest. This part of the fluid stream is followed by a later diffusional separation of components within that part.

Free flow electrophoresis on the microscale is particularly attractive because of the fast separation speeds observed and the possibility of working with small sample volumes. Furthermore, the large surface area to volume ratios in the microscale channels facilitate rapid heat transfer which minimises the detrimental effects of Joule heating even at high applied voltages. The resolution of microscale free flow electrophoresis—defined as the number of components differing in their charge to radius ratio that can be separated using this technique—is, however, limited due to the broadening of the component distribution when the component migrates in response to the electric field into a neighbouring carrier flow. Here, the broadening effects cause the distribution of components having different charge to radius ratios to overlap, such as significantly overlap, which reduces analytical resolution and complicates component separation.

Although a number of factors are believed to contribute to this broadening effect, one of the main factors is the differences in flow velocity that develop in the channel in the vertical profile of the flow. Here, the observed flow at and near the walls of the channel may be effectively zero. This leads to a variation in the times that different component molecules spend in the flow channel, therefore resulting in their differential deflection, and the resulting crescent effect lateral distribution of that component in the flow. A typical distribution is shown in FIG. 1.

The differential distribution of a component becomes particularly pronounced when high sample processivity is required. Increases in the rate of the fluid flow rate for both the component-containing flow and the carrier flow leads to an elevated pressure drop between the inlet and the outlet of the device. Consequently, according to the Hagen-Poisseuille relationship, an increased velocity gradient and variations in the residence times of the molecules.

The problem of differential deflection is recognised in the art, and various strategies have been proposed to reduce the differences. Many of these techniques have been reviewed by Shao et al. Example approaches include (i) condensing a component flow into a narrow band via approaches such as free-flow isotachophoresis, free-flow field step electrophoresis, or free-flow isoelectric focussing; (ii) increasing selectivity by introducing affinity probes to a component mixture; (iii) applying a dynamic coating on the inner walls of the chamber to reduce the broadening effects arising from electroosmotic flow; (iv) adjusting the conductance between the component flow and the carrier flow to avoid band twisting caused by electrodynamic distortion; (v) operating at an interval (discontinuous) free flow zone electrophoresis mode by selectively turning discontinuing the carrier medium flow to suppress hydrodynamic broadening.

The present inventors have now found an alternative approach to reducing the differential deflection of component molecules in free flow electrophoresis, and the approach has a general applicability to other free flow phoresis techniques.

### SUMMARY OF THE INVENTION

In a general aspect the present invention provides a fluidic device, which is typically a microfluidic device, for separating components. The fluidic device is provided with a first channel for supplying a first fluid flow, and the first channel joins with a second channel for supplying a second fluid flow at a junction. Downstream of the junction is a separation channel, which allows for the lateral distribution of components in contacting first and second fluid flows. The junction is adapted to provide the first fluid flow at least partially contained with the second fluid flow, such that the first fluid flow does not contact the separation channel walls, in particular the channel walls that are disposed along the length of the separation channel.

Furthermore, according to the present invention, there is provided a fluidic device comprising a separation channel having at its upstream end a junction, a first channel for supplying a first fluid flow, a second channel for supplying a second fluid flow, where the first and second channel meet at the junction, wherein the first and second channels are adapted to provide the first fluid flow in the separation channel sheathed by the second fluid flow, such that the first fluid flow does not contact the separation channel walls, wherein the separation channel, the first and second channels are provided as a unitary piece, or where the separation channel and the first and second channels are provided as a non-unitary piece comprising a plurality of parts, the parts are of the same material.

Parts of the fluidic device can be manufactured using the same materials which will reduce fabrication difficulties that can be caused by using different materials for different parts. For example, by using the same materials for all parts of the fluidic device, the physical and chemical properties for all the parts would be the same. Therefore, the first channel, second channel and the separation channel would possess the same electrical and/or thermal (conductive) properties. This ensures that, when the device is in use, the separation resolution of the device is not constrained by the materials from which the device is manufactured. In contrast, if the channels have different electrical or thermal (conductive) properties as a result of using different materials at the manufacturing stage, the differences in these properties may affect the separation resolution. In addition, providing the parts that are of the same material reduces one or more manufacturing processing step(s), which can increase efficiency and reduce manufacturing costs. The materials used to make the fluidic device can be plastic, polymers or glass and glass-like materials, or semiconductor materials such as Silicon, with very low conductivity. The semiconductor materials will be best suited to low voltage applications.

Furthermore, the separation channel, the first channel and the second channel can be co-moulded from the same material and then bonded together to provide a unitary piece. The co-moulding of the device as two pieces made from the same material provides a consistent, quick and efficient manufacturing stage obviating the need to bond different materials, which can be challenging. Furthermore, co-moulding multiple features in each of one or two moulded parts may considerably reduce the manufacturing tolerances between multiple individual pieces that must then be matched together. The consistency of results in moulding in a single material also helps to reduce the risk of a mismatch between the channels e.g. a mismatch of the physical dimensions between the first and second channels, which may, in turn, result in errors in the positioning of the sample fluid within the sheathing fluid flow. Moreover, the provision of a unitary piece fixes the separation between the first and second flow channels and thereby reduces uncertainty in fabrication of the device as a whole as the distance between the inlets and outlets on the first and second channels is fixed and known.

In some embodiments, the first channel may comprise at one of its end an injection nozzle inlet. The injection nozzle is intended to help a user to inject a sample into the middle of a microfluidic chamber. Sample injection into the main separation chamber at the middle of the device (3D injection) may help reduce or remove the analyte hydrodynamic broadening term when performing electrophoresis analysis and/or separation.

In some embodiments, the injection nozzle inlet has a curved geometry or a triangular geometry or a trapezoidal geometry. By adjusting the geometry of the injection nozzle inlet, it may be possible to control the cross-sectional shape of the first fluid flow sheathed by the second fluid flow without any external forces or active components required to shape the first fluid flow, other than pressure driven flow.

The curved geometry of the injection nozzle inlet may be configured to provide a circular cross section of the sheath flow. Preferably, the curved geometry of the injection nozzle inlet is selected from a group consisting of a semi-circular geometry, a circular geometry, or an elliptical geometry. In some embodiments, the semi-circular or circular geometry of the injection nozzle inlet can be advantageous because it gives a circular convection profile of the sheath fluid flow, thereby optimising the sample profile aspect ratio. Thus, by changing the curvature and/or the shape of the injection nozzle inlet, it makes it possible to control the convection profile i.e. hydrodynamic focussing effect of the sheath fluid flow.

In some embodiments, the cross section of the injection nozzle inlet is formed from a height and a width. The height can be 5, 10, 15, 20, 25, 30, 40 or 50 μm. The width can be 5, 10, 15, 20, 25, 30, 40, 50, 60, 70, 80 or 90 μm. Any combination of these heights and widths can be deployed to create a suitable cross section. In some embodiments, the cross section of the injection nozzle inlet can be 20×20 μm², which may provide a circular cross section of the sheath fluid flow. In some embodiments, the height and width of the injection nozzle inlet can be dictated by the height and/or length of the separation channel. Moreover, the height and width of the injection nozzle inlet can be dictated by the flow rate of fluid through the separation channel. The height and width can be selected the same or similar to one another, providing a square or substantially square cross section. Alternatively, an elongate cross section can be created by having the width considerably greater the height, or vice versa. At the end of the injection nozzle, the width can be increased over and above the inlet dimensions. In particular, the width could exceed 150, 250 or even 500 μm.

The invention provides a method for laterally distributing a component in a fluid flow, the method comprising the steps of:
(i) providing a component in a first fluid flow;
(ii) contacting the first fluid flow with a second fluid flow, such as to generate a laminar flow,
(iii) permitting the contacting fluid flows to flow in a separation channel, wherein the second fluid flow at least partially contains the first fluid flow, such that the first fluid flow does not contact the separation channel walls; and
(iv) allowing the component in the first fluid flow to join the second fluid flow in the separation channel, thereby to provide a distribution of the component across the contacting first and second flows.

The first fluid flow may be contained within the second fluid flow. The first fluid flow may be entirely contained, which may be described as sheathed, within the second fluid flow.

The volume of the separation channel may be at most 5,000 mm³.

Here, the separation channel walls are the walls of the separation channel disposed along the length of the channel, such as the channel base and side walls, and the top wall, where present.

In a further aspect there is provided a fluid method comprising the steps of:
(i) providing a component in a first fluid flow;
(ii) contacting the first fluid flow with a second fluid flow, such as to generate a laminar flow,
(iii) permitting the contacting fluid flows to flow in a separation channel, wherein the second fluid flow at least partially contains the first fluid flow, such that the first fluid flow does not contact the separation channel walls, for example such that the first fluid flow is contained within the second fluid flow; and
(iv) applying a force across the separation channel.

The volume of the separation channel may be at most 5,000 mm³.

In the methods of the invention, the fluid flows may be provided in microfluidic channels. The component may migrate from the second fluid flow in response to a force gradient across the channel, such an applied external force, preferably under an applied electric field. Thus, in the preferred embodiments the migration of a component may be under electrophoresis.

The first fluid flow may be provided as a flow having a substantially quadrilateral cross-section, such as rectangular or square cross-section, in the lateral cross-section of the contacting flows.

In a further aspect of the invention there is provided a fluidic device comprising a separation channel having at its upstream end a junction, a first channel for supplying a first fluid flow, a second channel for supplying a second fluid flow, where the first and second channel meet at the junction, wherein the first and second channels are adapted to provide the second fluid flow in the separation channel at least partially containing the first fluid flow, such that the first fluid flow does not contact the separation channel walls, particularly the channel walls that are disposed along the length of the separation channel.

The volume of the separation channel may be at most 5,000 mm³.

The first fluid flow may be contained within the second fluid flow. The first fluid flow may be entirely contained, which may be described as sheathed, within the second fluid flow.

The second channel may be adapted to introduce the second fluid flow non-parallel to the first fluid flow at the junction.

The separation channel may have a head wall at the upstream end of the channel at the junction, and the head wall has an outlet through which the first fluid flow is supplied by the first channel, and optionally, the outlet may be provided off centre to the centre of the separation channel.

The first channel is adapted to provide the first fluid flow having a substantially quadrilateral cross-section, such as rectangular or square cross-section, in the lateral cross-section of the contacting flows in the separation channel. Where the fluidic device is provided with an outlet, this outlet may be an orifice having a substantially quadrilateral cross-section.

The fluidic device according to an aspect of the invention may further comprise a flow separator at the downstream end of the separation channel for diversion of a part of the contacting fluid flows, and the diversion channel is for diversion a part of the lateral cross-section and/or the vertical cross-section of the contacting fluid flows.

In some embodiments, the separation channel, the first and second channels, and the flow separator channel can be provided as a unitary piece, or where the separation channel and the first and second channels are provided as a non-unitary piece comprising a plurality of parts, the parts are of the same material.

In further aspects of the invention there are provided an apparatus and a method for collecting a component in a fluid flow, such as a component having a limited lateral distribution in a fluid flow.

In yet a further aspect there is provided a method of collecting a component having a distribution across contacting first and second fluid flows in a separation channel, the method comprising the step of diverting a part of the contacting first and second fluid flows, wherein the part is a part of the lateral cross-section of the fluid flows and/or a part of the vertical cross-section of the fluid flows, wherein the diverted part contains the component.

Typically the part of the contacting first and second fluid flows that is diverted is a part that is wholly contained within the contacting first and second fluid flows. That is, the part diverted is typically not a part of the fluid flows that contacts the separation channel walls.

Preferably the device is adapted for use in electrophoresis, and the methods of the invention use electrophoresis to induce migration of components in a flow channel.

These and other aspects and embodiments of the invention are described in further detail below.

### SUMMARY OF THE FIGURES

FIG. 1 is a schematic of a fluid flow in a separation channel of a known free flow electrophoresis separation device. The pressure difference between the inlet and the outlet of the separation channel leads to a parabolic velocity profile along the height of the chamber with nearly zero velocity in the vicinity of its walls (as shown in the inset figure). This leads to a variation in the residence times of the analyte molecule in the device and the broadening of the analyte beam from width w₀ to w, substantially limiting the resolution of the separation process.

FIG. 2 shows (a) a schematic of a fluidic device according to an embodiment of the invention, where the scale bar is 500 μm. The worked examples in the present case make use of a device having the design shown in this figure, and images of the separation channel of a device made to this design are shown (the scale bars in these images are 500 μm); and (b) a schematic of fluid flow in a separation channel of a fluidic device according to an embodiment of the invention, where a component fluid flow is introduced into a second flow at a junction at the upstream end of a separation channel, such that the component flow is entirely contained (sheathed) within the second fluid flow. The head wall of the junction contains an orifice through which the component fluid flow is delivered to the junction. Shown above the schematic is an image of head wall of a separation channel in a fluidic device according to an embodiment of the invention. The orifice is suitable for providing a component fluid flow having a substantially quadrilateral cross-section.

FIG. 3 shows (a) a schematic of a fluidic device according to an embodiment of the invention showing the cross section of the device in the flow direction of the fluidic separation channel; and (b) and (c) are a series of images showing the deflection of a component flow in a channel by electrophoresis using (b) a device of the type know from the prior art, such as shown in FIG. 1 where the component flow in the separation channel is the full height of the channel, and (c) a device according to an embodiment of the invention, as shown in FIG. 3(a), where the component flow in the separation channel is contained within the full height of the channel, such that the flow does not contact the channel walls. The images show the component flow in response to no applied filed (0 V), and 50 and 140 V cm⁻¹ applied field. The walls of the separation channel are defined by the fluorescent interface on the sides.

FIG. 4 shows (a) the distribution profile for a component in contacting component and second fluid flows in a separation channel in free flow electrophoresis experiments, where the distribution is shown at different field strengths, where the component population at a channel position is measured by fluorescence intensity (a.u.). Here, the component fluid flow is established across the full height of the separation channel. The field strength was increased linearly between 0 V cm⁻¹ (red) and 140 V cm⁻¹ (blue); (b) the distribution profile in free flow electrophoresis experiments where the component fluid flow is entirely contained within the second fluid flow, such that the first fluid flow does not contact the separation channel walls; and (c) the change in distribution profiled, as measured by the full width at half height (μm), with the change in deflection (μm) as compared between a free flow electrophoresis method according to the prior art, where the component fluid flow is established across the full height of the separation channel (“Full height”), and a method according to an embodiment of the invention, where the component fluid flow is entirely contained within the second fluid flow, such that the first fluid flow does not contact the separation channel walls (“Controlled”).

FIG. 5 shows the simulated distribution profiles for a component in free flow electrophoresis experiments, where there is no applied field or an applied field, and the component flow is contacted with a second fluid flows to establish contacting flows in a separation channel, and the first fluid flow occupies differing amounts in the vertical aspect of the lateral cross-section of the separation channel, and where there is optionally a diversion of a part of the contacting fluid flows. The figures show simulated experiments with (a) a flow rate of 200 μL h⁻¹ and applied field of 0 and 4 V; (b) a flow rate of 800 μL h⁻¹ and applied field of 0 and 16 V; and (b) a flow rate of 2,000 μL h⁻¹ and applied field of 0 and 48 V.

FIG. 6 shows (a) the simulated distribution profiles for a component in free flow electrophoresis experiments, where there is no applied field or an applied field, and the component flow is contacted with a second fluid flows to establish contacting flows in a separation channel, and the first fluid flow is sheathed by the second fluid flow, and where there is a diversion of a part of the contacting fluid flows that occupies the full channel height, or a fraction of the channel height; and (b) a schematic showing the distribution of components in a downstream end of a separation channel, where the channel contains contacting component and second fluid flows, and the component flow is entirely contained (sheathed) within the second fluid flow. Here, the contained first fluid flow has a substantially rectangular cross-section across the channel. The schematic shows the vertical diffusion of components in the separation channel. A portion of the contacting component and second fluid flows may be diverted, and this portion is a part of the flow height, and is contained within the height, as shown by the dashed lines in the cross-section.

FIG. 7 provides a schematic diagram of a 3D injection nozzle inlet allowing for the control of the convection profile of a fluid flow;

FIGS. 8 (a) and (b) shows the convection profile of an injected fluid flow using an injection nozzle inlet having a flat geometry;

FIGS. 9 (a) and (b) shows the convection profile of the injected fluid flow using an injection nozzle inlet having a triangular geometry;

FIGS. 10 (a) and (b) shows the convection profile of the injected fluid flow using an injection nozzle inlet having a high aspect ratio triangular geometry;

FIGS. 11 (a) and (b) shows the convection profile of the injected fluid flow using an injection nozzle inlet having an elliptical geometry;

FIGS. 12 (a) and (b) shows the convection profile of the injected fluid flow using an injection nozzle inlet having a circular geometry;

FIGS. 13 (a) and (b) provide an intuitive comparison between (a) a flat nozzle and (b) a triangular nozzle convection profiles, according to FIGS. 8 and 9 respectively;

FIG. 14 shows an optimised device design. A sample profile is assumed to be circular where the radius is determined by only the sample to the total flow ratio Q_{S}/Q_{T};

FIGS. 15 (a) and (b) shows the desired injection nozzle inlet geometry;

FIG. 15 (c) shows a top view of the proposed design and (d) shows the injection nozzle inlet as modified slightly by simulations to capture the main design features;

FIG. 16 shows a fluid flow profile within the proposed injection nozzle as shown in FIGS. 15 (a) and (b);

FIG. 17 shows an equilibrated sample injection profile, which can be approximated as a circular cross-section region. The co-flow buffer (Fluid1) is Q_{B}=450 ul/h and the sample (Fluid 2) flow is Qₛ=10 ul/h;

FIGS. 18 (a), (b) and (c) shows the sample injection flow streamlines and FIG. 18 (d) show that the sample approximately occupies a circular cross-sectional shape sample beam;

FIGS. 19 (a), (b), (c), (d), (e) and (f) shows a fluidic device misaligned during the bonding process by 50 μm across the width of the device; and

FIGS. 20 (a), (b), (c), (d), (e) and (f) shows a fluidic device misaligned during the bonding process by 50 μm along the sample fluid flow direction.

### DETAILED DESCRIPTION

The present invention provides methods for separating a component and a device for use in such a method, such as methods for the separation of component by phoresis, and most particularly electrophoresis.

Some of the present inventors have previously shown that fluidic methods may be used to separate components in a fluid flow of a component mixture by differential migration of components from the component fluid flow into a contacting second, or carrier, fluid flow. A component may be collected, at least partially separated from other components, by collection of a fraction of the contacting fluid flows containing the component of interest. The other components may be collected by diversion of other portions of the contacting fluid flows. This work is described in WO 2015/071683.

The present inventors have now established that changes to the component fluid flow and the second fluid flow may be made to improve the migration profile of a component, and thereby to improve the separation of that component from other components.

In known phoresis methods, a first fluid flow of a component mixture is brought into contact with a second fluid flow of at an upstream junction. A laminar flow of the first flow with the second flow is established, and is permitted to flow along a separation channel. The application of a field across the flow in the separation channel induces migration of components from the first flow into the second flow. The migration of a component in response to the applied field gives rise to a sizeable lateral distribution of the component in the downstream flow. This distribution of component can be explained by the reduced velocities of the fluids at and close to the separation channel walls, and more specifically the separation channel walls disposed along the length of the channel, which leads to greater residence times of the components at these regions, and hence a difference in the deflection of the components in response to an applied force.

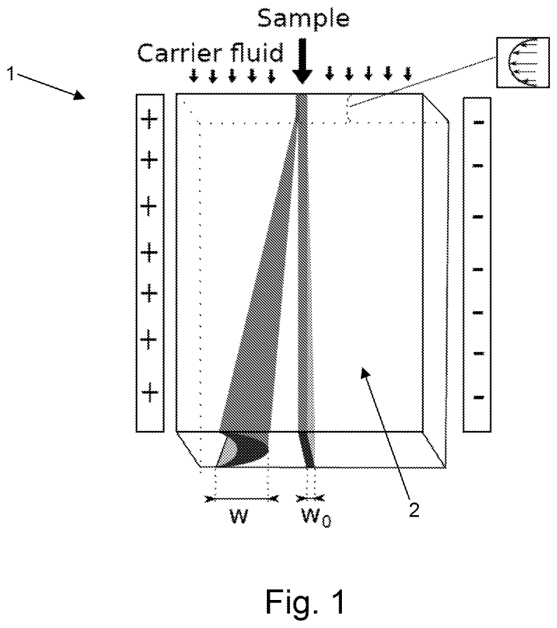

FIG. 1 is a schematic of a flow device for use in methods of separating components by electrophoresis. The figure shows the lune-shaped lateral distribution profile of the deflected component in a downstream region of the distribution channel. Thus, there is a lack of confinement in the distribution of the component during the deflection of that component in the separation channel.

The lack of confinement is a problem related to the vertical distribution of the component in the lateral distribution profile, as it is the top and/or bottom portions of the fluid flow that contact the walls of the separation channel that are disposed along its length.

In order to collect the migrated component it is necessary to collect a considerable portion of the fluid flow. This collected portion may also comprise other components, whose lateral distribution is also not particularly confined.

Alternatively, it may only be possible to collect a portion of the fluid flow, in order to minimise the amount of other components that are collected with component of interest. The lateral distributions of these other components also have a sizeable lateral extent, which may significantly overlap with that of the component of interest. Thus, the inventors have considered adaptation of the flow device and flow methods that will address the problem of lack of confinement in the lateral distribution of a component.

The present inventors have found that the lateral distribution of a component may be contained when the fluid flow of the component does not contact the walls of the fluidic device. Therefore, the component flow is established away from the bottom surface and top surface, where present, of the walls of the separation channel.

Accordingly, the methods of the invention establish a component fluid flow contacting a second fluid flow in a separation channel, where the second fluid flow at least partially contains the component fluid flow, such that the component fluid flow does not contact the separation channel walls.

The device of the invention is a fluidic device having first and second fluid flow channels for supplying first and second fluid flows, where the channels join at a junction at an upstream end of a separation channel, wherein the junction is adapted to provide a first fluid flow contacting a second fluid flow in the separation channel, where the second fluid flow at least partially contains the component fluid flow, such that the component fluid flow does not contact the separation channel walls.

Weber and Bocek have previously described a free flow fluidic device where a component fluid flow is entirely sheathed by a second fluid flow. The contacting fluid flows are exposed to an applied electrical field to effect a deflection of the components within component fluid flow into the second fluid flow.

The methods and apparatus of the present case differ from the methods and apparatus of Weber and Bocek in many respects.

Weber and Bocek describe the use of a separation zone having dimensions of 100 mm in width, 500 mm in length and a depth of 0.4 mm. The volume of the separation channel is clearly very large (20,000 mm³). The methods and device of Weber and Bocek are consequently unsuitable for use with small sample sizes.

In contrast, the preferred fluidic device for use in the present case has considerably smaller dimensions, for example in one or both of the separation channel width and length, and optionally, although not essentially, also a smaller channel depth. Accordingly, the volume of the separation channel is not large. In preferred embodiments, the volume of the separation channel is at most 1,000 mm³.

The use of fluidic methods in the present case permits the analysis of smaller samples than possible with the methods of Weber and Bocek. Further, fluidic methods allow for a faster analysis time, which in turn allows for the study of kinetic processes in real time, including those binding processes having fast on and off rates. A further advantage of fluidic methods lies in the reduced Joule heating owing to an increase in the surface area to volume ratio.

Furthermore, the fluidic device for use in the present case, containing the separation channel and first and second fluid channels is preferably of a single material. The fluidic device may be formed from PDMS, for example using photolithography. Alternatively, the fluidic device may be formed from plastics materials, for example using moulding or embossing techniques. Here there is considerable design freedom to form channels of various shapes and sizes, particularly on the micro scale.

In contrast, the work of Weber and Bocek uses a glass capillary as the flow channel for the first fluid flow. This provides constraints on the size and the cross-sectional shape of the component flow. Moreover, adaptations to the size and the cross-section shape are difficult as these require intricate shaping of glasswork, which is not practicable, particularly on a microscale.

Third, the methods of the invention may use a fluidic device having a junction where second fluid flows are brought into contact with a component fluid flow. Here, the junction allows for the development of a stable flow in short time, and the contacting flows may be exposed to an applied force very soon after contacting at the junction.

The devices of the present invention may be prepared with great precision, for example using photolithographic-based construction techniques. Where there is a distance between the junction and the location in the separation channel where the field is applied, that distance may be precisely defined, and known, from the construction methods that are employed. The present invention allows fluid devices having great homogeneity between devices to be prepared, thereby allowing great reproducibility in the methods of the invention.

In the work of Weber and Bocek a component flow is brought into contact with a second fluid flow substantially parallel with the direction of the second fluid flow. Weber and Bocek use this contact geometry to avoid the problem of shearing, which was observed when the first fluid flow was contacted with the second fluid flow substantially orthogonal to the first flow direction.

In the present case there is a freedom to control fluid flow at the nozzle, which is the upstream portion of the separation channel, where the first and second fluid flows are brought into contact. The angled, or non-parallel, introduction of a second fluid flow to the component-containing first fluid flow may allow a stable contacting flow to be rapidly established, thereby allowing the contacting flows to be exposed to an external force, such as electrical field, substantially immediately after initial contacting of the fluid flows. The design freedom in the present case is available through the use of photolithographic or molding techniques in device fabrication. Here, it is possible to prepare channel junctions having any desired geometry, including channels which meet at an angle, and it is possible to do so with accuracy and reproducibility.

The work of Weber and Bocek is limited for the reason that the apparatus relies on a glass capillary to act as a channel for the fluid flow containing the component. The glass capillary cannot be easily and reproducibly scaled for use in smaller fluidic device, for example a microfluidic, as glass working on such a scale is not practicable. Further, in the apparatus of Weber and Bocek the capillary apparently cannot be used to provide an angled fluid flow, as the placement of the capillary is by necessity directly placed in flow of the sheathing flow (or carrier flow), and angling that capillary will inevitably disrupt the flow of that sheathing flow.

There is a strong possibility that the repeated performance of a phoresis method using the apparatus of Weber and Bocek will not be reliable. The preparation of identically proportioned capillaries may be difficult, and the accurate manual placement of that capillary into the flow channel will also be difficult, which will likely lead to problems in capillary alignment within the larger separation channel.

In earlier work some of the present inventors have shown that the design of a junction, which may include the angled introduction of a second flow to a first flow and the angling of the nozzle itself, can advantageously improve the stabilisation time for the contacting flows. See, for example, WO 2014/064438.

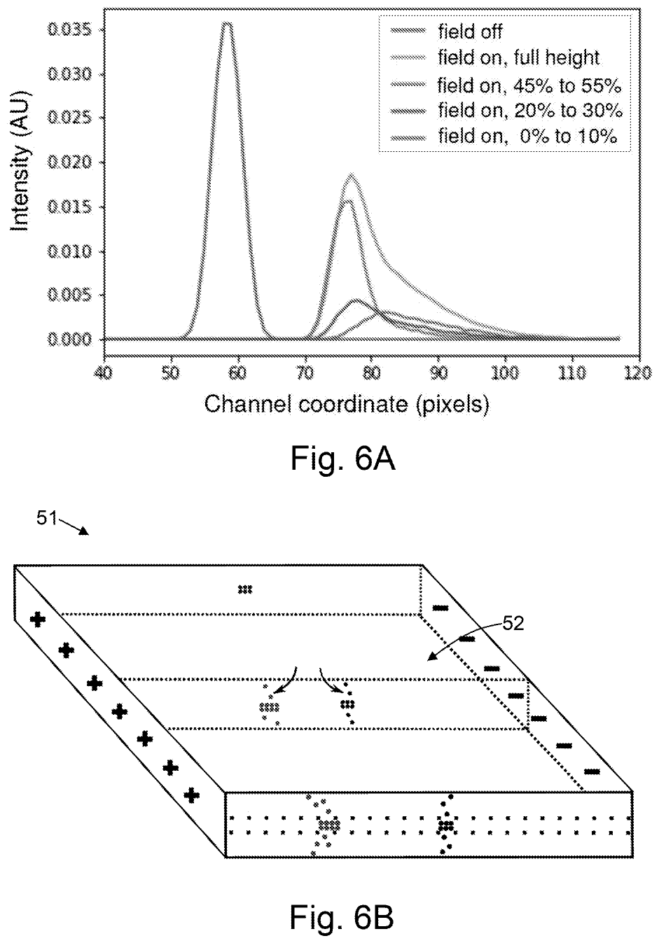

Fourth, the preferred methods of the invention may include the step of diverting a part of the contacting fluid flows at a downstream end of the separation channel. This diversion step allows a component to be at least partially separated from other components that are differentially distributed across the contacting fluid flows. Further, the most preferred methods of the invention include the step of diverting a part of the contacting fluid flows that is entirely contained within (or surrounded by) the remaining part of the contacting fluid flows. Here, a greater resolution of the component obtained from the diversion and subsequent collection of the component. This is shown schematically in FIG. 6(b).

Weber and Bocek do not describe the diversion of a part of the contacting fluid flows at a downstream end of the separation channel. Instead, Weber and Bocek simply collect all the contact fluid flows in a single outlet at the downstream end. Thus, the methods and apparatus of Weber and Bocek are not capable of allowing the at least partial separation of one component from another.

Some of the present inventors have previously described in WO 2015/071683 the diversion of a part of the contacting fluid flows at a downstream end of the separation channel. Here, the part of the contacting fluid flows that was diverted was a part having the full height of the fluid flow in the separation channel. In certain methods of the present invention, the part that is diverted is not the full height of the flow, but is a part of the full height, and is preferably a part that is fully contained within the full height. As noted above, there is a greater resolution of the component obtained from the diversion and subsequent collection of the component.

Methods

The methods of the invention generally look to analyse, such as characterise or quantify, a component in a solution. The methods of the invention may alternatively or additionally be used to separate a component from one or more other components in a solution.

A first fluid flow comprising one or more components is brought into contact with a second fluid flow in a separation channel, such as to generate a laminar flow. The contacted flows are permitted to flow along the separation channel and components in the first fluid flow are permitted to move into the second fluid flow, to provide a distribution of the components across the first and second fluid flows. The movement of a component is typically under the influence of an external force, such as an applied electrical field. Thus, the movement may be phoretic, which is to say using phoresis techniques, such as electrophoresis and thermophoresis.

In the methods of the invention, the second fluid flow at least partially contains the first fluid flow, such that the first fluid flow does not contact the separation channel walls, such as those disposed along the channel length, for example such that the first fluid flow may be entirely contained within, or sheathed by, the second fluid flow.

Here, the first flow may also be referred to as a component flow. The second flow may also be referred to as a carrier flow.

Subsequently a part of the contacting fluid flows may be diverted for labelling, analysis or collection of the components within that diverted part. This diversion may also serve to at least partially purify a component in the contacting fluid flows from other components laterally distributed across the fluid flows. The part of the contacting fluid flows that is diverted is a portion of the lateral cross-section of the contacting fluid flows, and optionally may also be a portion of the vertical cross-section of the contacting fluid flows. Typically, that diverted portion does not contain the first fluid flow. Instead, the diverted portion is derived from the second fluid flow into which a component has been deflected in response to the force applied across the separation channel.

The separation channel is part of a fluidic device, and most preferably a microfluidic device. The fluidic device may be adapted for use with a detector for the components.

The flow rate of each of the first and second fluid flows is maintained at a substantially constant level during the separation step, and also the diversion labelling and analysis steps, where present. The separation, step may be undertaken only when a stable flow is established in the separation channel.

The component may be or comprise a polypeptide, a polynucleotide or a polysaccharide. In one embodiment, the component is or comprises a polypeptide. In one embodiment, the component is or comprises a protein.

The component may be part of a multicomponent mixture. The separation step may therefore be used to at least partially separate the component from other components. For example, the techniques described herein allow for separation based charge-to-size ratio, amongst others.

The worked examples in the present case use bovine serum albumin (BSA), by way of example.

In one embodiment, the multicomponent mixture comprises agglomerations of components, including proteins, such as monomer, dimer and trimer species, or other higher order agglomerations. Thus, the techniques described herein may be used to separate different assemblies, such as protein assemblies, and analyse protein-protein interactions.

In one embodiment, the component has a largest dimension of at most 50 nm, at most 100 nm, at most 500 nm, or at most 1,000 nm.

In one embodiment, the component has a largest dimension of at least 0.1 nm, at least 0.5 nm, at least 1 nm or at least 5 nm.

The component may have a largest dimension with maximum and minimum dimensions selected from the values given above. For example, the component may have a largest dimension in the range 1 to 100 nm.

The largest dimension may refer to the largest cross-section which may be the diameter of a component that is derviable from the hydrodynamic radius of that component.

Fluid Flows

The present invention provides methods of separation and analysis for a component provided in a fluid flow. In one embodiment, a reference to a fluid flow is a reference to a liquid flow.

A fluid flow may be an aqueous flow. An aqueous flow may include other solvents, such as DMSO, alkyl alcohol and the like.

The devices of the invention may be adapted for use with fluid flows, and may be adapted for use with aqueous fluid flows.

In embodiments of the invention, the component is initially provided in a first fluid flow. The component is preferably dissolved in the first fluid.

In one embodiment, the first fluid allows a component or components to remain in its native state. Where the component is a biomolecule, such as a protein, the fluid flow may be a suitable buffer. Thus, the salt content and pH, amongst others, may be selected to retain the component in its native state.

The second fluid flow may be identical to the first fluid flow, except that the second fluid flow does not contain the component. Optionally, the second fluid flow may differ from the first fluid flow in other respects, for example, with the second fluid flow containing constituents that are not present in the first fluid flow. The second fluid flow may be provided with these constituents for use in phoresis in the separation channel, such as where the phoresis is an isotachophoresis technique.

In the methods described herein, general reference is made to a second flow, which may be a substantially homogeneous fluid flow. However, the invention also encompasses methods where the second fluid flow is composed of a plurality of sub flows, which together provide a second flow for at least partially encompassing the first fluid flow, such as sheathing the first fluid flow.

The sub flows may differ from one another in their composition. For example, where sub flows are to be used in isotachophoresis experiments, the sub flows may differ in their ion composition from one another, for example with one flow having a low ionic motility and the other having a high ionic motility. Each sub flow differs from the first fluid flow.

In the preferred methods and apparatus of the invention, the first fluid flow is brought into contact with two second fluid flows at a junction at the upstream end of the separation channel. Typically, each of the second fluid flows is the same, and they may be provided from a common upstream reservoir. However, in these embodiments, the second fluid flows may differ, and they may be provided from separate upstream reservoirs.

The first and second fluid flows are brought into contact, and component in the first flow is permitted to move into the second flow, in response to a gradient across the separation channel. This gradient may be an externally applied gradient, or it may be a gradient that is provided in the channel through the appropriate selection of second fluid flows.

A component may migrate in response to the gradient across the channel, such as under the influence of an applied external force, to generate a distribution of the component across first and second fluid flows. The contacting flows may be a laminar flow of the first flow with the second flow.

The first and second flows may be brought into contact in a way such that the second flow at least partially contains the first fluid flow, such that the first fluid flow does not contact the separation channel walls.

The first and second flows may be brought into contact in a way such that the first flow is entirely contained within the second flow. Thus, the first flow may be regarded as sheathed by the second flow.

The second fluid flow may be a unified flow. Thus, the second fluid flow is not a plurality of flows separated by the first fluid flow. The second fluid flow contacts the first fluid flow at the lateral faces of the first fluid flow, and also one or both of the inferior and superior faces of the first fluid flow.

The first fluid flow may be provided as a flow having a substantially quadrilateral cross-section, such as rectangular or square cross-section, in the lateral cross-section of the contacting flows. A first fluid flow having such an arrangement with the second fluid flow may allow for a more even and predictable migration of the component in response to the applied force in the separation channel.

The flow rate of the contacting first and second fluid flows is selected as appropriate for the experiment, for example taking into account desired resident times for the component in the separation channel. The selection of appropriate flow rates is well known to the skilled person.

In a typical method the flow rate for the contacting first and second fluid flows, such as in the separation channel, is at least 5, 10, 50, 100, 200 or 500 μL h⁻¹.

The flow rate is at most 2,000, at most 5,000 or at most 10,000 μL⁻¹.

In one embodiment, the flow rate may be in a range selected from the upper and lower values given above. For example, the flow rate may be in the range 200 to 2,000 μL⁻¹.

It is noted that the continuous flow electrophoresis methods described by Weber and Bocek are performed at a flow rate of 60 mL h⁻¹, which is considerably above the upper limit for the preferred flow rate for the contacting first and second fluid flows in the present case. The methods of Weber and Bocek are therefore not suitable for small volume samples, whereas the methods and apparatus of the present may be used on small scale.

In the methods of the invention the flow rate of the first fluid flow as it enters the junction is less than the flow rate of the second fluid flow as it enters the junction. Here, the second fluid flow rate may refer to the combined fluid flow rate, for example when two fluid flows contact the first fluid flow at the junction.

In one embodiment, the flow rate of the second fluid flow is 2 or more, 5 or more, 10 or more, 20 or more, 50 or more, or 100 or more times the flow rate of the first fluid flow. The flow rates of the individual flows may be controlled by appropriate use of, for example, syringe pumps.

In the methods of the present case a first fluid flow is at least partially contained within, such as sheathed by, a second fluid flow. In the combined flow, the second fluid flow is typically and preferably the predominant portion of the combined flows.

In the lateral cross section of the contacting fluid flows, such as where the combined fluid flow is established at the upstream junction of the separation channel, the second fluid flow preferably occupies a significant portion of the flow width and preferably occupies a significant portion of the flow height. The relative flow rates of the first and second fluid flows may be altered to provide the desired ratio of first to second fluid flows.

In preferred embodiments of the invention the second fluid flow occupies a significant portion of the flow width and a significant portion of the flow height.

In the contacting fluid flows, the first fluid flow may occupy at most 40% of the total width of the contacting fluid flows, such as at most 30%, such as at most 20%, such as at most 10%, such as at most 5%.

Typically, the first fluid flow occupies 5 to 10% of the total width of the contacting fluid flows.

In the contacting fluid flows, the first fluid flow may occupy at most 40% of the total height of the contacting fluid flows, such as at most 30%, such as at most 20%, such as at most 10%, such as at most 5%.

Typically, the first fluid flow occupies 5 to 10% of the total height of the contacting fluid flows.

Here, the total width and total height of the contacting fluid flows may also refer to the separation channel width and height, in which the contacting first and second fluid flows are contained.

The occupancy of the first fluid in the width of the contacting fluid flows may be quoted with respect to that width of the first fluid flow at the mid-point of the vertical distribution of the first fluid flow (the mid-point between the uppermost point and the lowermost point) in the lateral cross section of the contacting fluid flows.

The occupancy of the first fluid in the height of the contacting fluid flows may be quoted with respect to that height of the first fluid flow at the mid-point of the lateral distribution of the first fluid flow (the mid-point between the lateral most points) in the lateral cross section of the contacting fluid flows.

The mid-point of the first fluid flow in the width or the height distributions may also be the midpoint of the separation channel. Here, the orifice for introducing the first fluid flow to the separation channel may be centred in the upper wall of the separation channel.

However, it is not essential for the mid-point of the first fluid flow to be provided at the midpoint (centre) of the separation channel. The methods and apparatus of the present invention also allow the first fluid flow to be provided off centre. Indeed, the first fluid flow may be provided at any off-centre point, so long as the first fluid flow is spaced from the channel walls, and preferably such that the first fluid flow is sheathed by the second fluid flow.

The first fluid flow may be provided vertically off-centre or laterally off-centre, or both.

The location of the first fluid flow in the separation channel, which is optionally entirely sheathed by the second fluid flow, may be directed by the placement of a first fluid flow outlet, for example in a head wall of the separation channel, which supplies first fluid from a first fluid channel. The head wall is provided at the junction at the upstream end of the separation channel. This outlet may be off-centre, such as vertically off-centre or laterally off-centre, or both, to provide an off-centre first fluid flow.

Separation of Components

The method of the invention may include the distribution of a component across the first and second fluid flows. The component may move laterally across the contacting fluid flows in response to a gradient that is provided across the separation channel, such as an applied external force. Thus, the movement of a component may be referred to as a deflection. The deflection typically causes movement of the component from the first fluid flow into the second fluid flow.

The methods of the invention allow the movement of the component in response to a gradient that is present within the separation channel. This gradient may be an electrical (voltage) gradient, a temperature gradient, or an ionic gradient.

The distribution may comprise the electrophoretic movement of the component into the second fluid flow.

The distribution is the lateral distribution of the component or a multicomponent mixture comprising the component.

Preferably the methods of the invention are electrophoresis methods. Thus, the migration of a component in the separation channel may be in response to an applied electric field.

However, the methods of the invention are not limited to electrophoresis methods, and other methods may be used. As an example, thermophoresis methods may be used. Thus, the migration of a component in the separation channel may be in response to an applied temperature gradient.

Other phoresis methods may be employed in order to induce the migration of components across the separation channel, and optionally also to induce the at least partial lateral separation of components across the channel. For example, isotachophoresis techniques may be used to deflect the component. Here, an external force is not applied across the separation channel. Rather a gradient may be set up in the separation channel by appropriate choice of the second fluid constituents.

The fluidic device may be adapted to allow the application of a force, such as force gradient, across the separation channel.

In the methods of the invention, a first component fluid flow is established in a separation channel, and that flow does not contact the separation channel walls disposed along the separation channel length, for example the component flow is sheathed by a second fluid flow. Here, then, the second fluid flow may be provided below the first fluid flow, and optionally also above the first fluid flow. The second fluid flow is also provided at either side of the first fluid flow. In the phoresis experiments described herein, the component may move laterally into the second fluid flow under the influence of the applied field. It is also the case that a component may move, such as by diffusion, vertically into the second fluid flow that is below and optionally above the first fluid flow. This movement of the component is shown schematically in FIG. 6(b).

The vertical distribution of the component in the second fluid flow is observable with and without the application of the field.

In an aspect of the present invention, there is provided a method for collecting a component having a distribution across contacting first and second fluid flows in a separation channel, the method comprising the step of diverting a part of the contacting first and second fluid flows, wherein the part is a part of the lateral cross-section of the fluid flows and a part of the vertical cross-section of the fluid flows, wherein the diverted part contains the component.

This aspect of the invention may be combined with other aspects of the invention, which provide for the generation of contacting first and second fluid flows in a separation channel, where the second fluid flow at least partially contains the first fluid flow, such that the first fluid flow does not contact the separation channel walls, such as wherein the first fluid flow is contained within the second fluid flow.

In the contacting fluid flows, the diverted flow containing the component may be a part that is at most 40% of the total width of the contacting fluid flows, such as at most 30%, such as at most 20%, such as at most 10%, such as at most 5%. Typically, the diverted flow containing the component is a part that is 5 to 10% of the total width of the contacting fluid flows.

In the contacting fluid flows, the diverted flow may be at most 40% of the total height of the contacting fluid flows, such as at most 30%, such as at most 20%, such as at most 10%, such as at most 5%. Typically, the diverted flow is 5 to 10% of the total height of the contacting fluid flows.

The proportion of the flow that is diverted, with respect to the width or height of the contacting flows, or both, may be same proportion of the flow that is generated by the component fluid flow at the junction when the component flow is brought into contact with the second fluid flow.

Where some of the present inventors have described the collection of a portion of the fluid flow from the downstream end of a separation channel, this portion is a portion of the lateral distribution of the combined fluid flows only. Thus, WO 2015/071683 describes the diversion of a portion of the lateral distribution of the contacting first and second fluid flows. In each case the entirety of the vertical cross-section of the fluid flows are collected. There is no suggestion that a portion of the vertical distribution could and should be diverted.

The inventors have found that the resolution of a collected sample may be enhanced if the portion of the sample that is collected does not comprise the entire vertical component of the fluids in the separation channel.

The collection of a portion of the vertical and horizontal cross-sections of the contacting fluid flows may be achieved by a diversion of this portion from the remaining contacting fluid flows. Typically, a diversion channel is provided at a downstream end to divert that portion. The opening to this channel may be an orifice in a downstream head wall in the separation channel.

The remaining portions of the contacting fluid flows may be collected via separate diversion channels.

The force applied across the separation channel may be varied to allow an appropriate degree of deflection of the component, such that the lateral movement of the component in the separation channel is aligned to the diversion channel at the downstream end.

Additionally, or alternatively, the flow rate of the first and second fluid flows may also be varied to control the degree of lateral movement of the component at the downstream end of the separation channel. Again, this variation may be used to align the flow of deflected component with the diversion channel at the downstream end.

The device of the invention may be provided with a fluid junction to establish a component flow that is at least partially contained within a second fluid flow. The component flow may be referred to as sheathed by the second flow where the first fluid flow is entirely contained within the second flow.

Thus, the flow of the second fluid, as observed in the lateral cross section of the separation channel, is continuous, and is not broken by the component flow.

The flow apparatus makes use of small fluidic channels, particularly microfluidic channels, and therefore very small sample volumes may be analysed. Thus, components provided in fluids of less than a microliter volume may be analysed by the methods described herein. Furthermore, fluid flow techniques can also be used to analyse very dilute samples, by appropriate increases in the measurement times.

The cross sections of the separation channel, the diversion channel and the detection channel are typically in the micrometre range, and the fluidic device for use in the method of the first aspect of the invention may therefore be referred to as a microfluidic device.

However, it is also possible to use fluidic devices where one dimension of the channel cross section is in the millimetre or centimetre range, such as the width of the separation channel is in the millimetre or centimetre range. Here, the depth of the channel will be in the micrometre range. The dimensions of the separation channel may be selected to allow for relatively small volumes within the separation channel, such as described below. Typically the separation channel length is not generally limited.

The present invention also provides the microfluidic device as described herein.

The separation channel has suitable dimensions allowing for the generation and maintenance of a laminar flow of two (or three) streams within. The laminar flow of two streams means that the flows are side by side and are stable. Thus, there are typically no regions where the fluids recirculate, and the turbulence is minimal. Typically, such conditions are provided by small channels, such as microchannels.

The general dimensions of the channels in the device are selected to provide reasonable mobilisation rates and analysis or separation times. The dimensions of the device may also be selected to reduce the amount of fluid required for a sufficient analysis or separation run.

Downstream from the junction, the separation channel has a substantially constant width throughout its length.

The width of the separation channel may be at most 700 μm, at most 1,000 μm (1 mm), at most 2,000 μm (2 mm), at most 3,000 μm (3 mm), at most 5,000 μm (5 mm), at most 10,000 μm (10 mm), or at most 25,000 μm (25 mm). The width of the separation channel may be at least 5 μm, at least 10 μm, at least 50 μm, at least 100 μm, at least 200 μm, or at least 500 μm. In one embodiment, the width of the separation channel may be in a range selected from the upper and lower values given above. For example, the width may be in the range 500 to 3,000 μm.

The length of the separation channel may be of a length suitable to allow for adequate lateral movement of a component from the first fluid flow. The length of the separation channel may be the length of the channel that is bounded by the junction at the upstream end of the separation channel, and a flow separator at the downstream end of the separation channel, where such is provided. The downstream end of the separation channel may also be defined as the point of the channel where the applied force for the phoresis is no longer experienced or applied.

In one embodiment, the separation channel is at least 0.5 mm, at least 1 mm, at least 2 mm, at least 5 mm, or at least 10 mm long. In one embodiment, the separation channel is at most 10 mm, at most 20 mm, at most 50 mm, or at most 100 mm long. In one embodiment, the separation channel length may be in a range selected from the upper and lower values given above. For example, the separation channel length may be in the range 0.5 to 50 mm, such as 1 to 20 mm. In one embodiment, the height of the separation channel is at least 1 μm, 5 μm, 10 μm, or 25 μm.

In one embodiment, the height of the separation channel is at most 75 μm, 100 μm, 200 μm, 300 μm or 500 μm. In one embodiment, the separation channel height may be in a range selected from the upper and lower values given above. For example, the separation channel length may be in the range 5 to 100, such as 25 to 75 μm.

The second fluid flow channel may have the same height as the separation channel. The first fluid flow channel has a height that is less than the separation channel height. The first fluid channel height may be at most 90%, at most 80%, at most 70%, at most 50% or at most 40% of the separation channel height.

In one embodiment, one or two, such as one, of the separation channel length, height or width may have dimensions of at least 1 mm, such as the separation channel width and length may have dimensions of at least 1 mm. Here, the other dimensions for the separation channel, such as the channel width, may be 1 mm at most.

The methods and apparatus of the present case may be used at considerably smaller volumes than the methods and apparatus of Weber and Bocek, where the separation channel has a volume of 20,000 mm³. In one embodiment, the volume of the separation channel is at most 100 mm³, at most 500 mm³, at most 1,000 mm³, at most 2,000 mm³, at most 5,000 m³, at most 10,000 mm³, or at most 15,000 mm³. Preferably, the volume of the separation channel is at most 1,000 mm³

The fluidic device may be provided with supply channels providing fluid communication between the reservoir and the separation channel.

Each reservoir may be a syringe which is connected to a supply line of the microfluidic device. The syringe may be under the control of a suitably programmed computer which is capable of independently controlling the flow rate of fluid from the reservoir to the large section channel. The control of such devices is well known in the art.

Alternatively each reservoir may be provided as part of the microfluidic device.

In other embodiments, syringes are provided at a downstream end of the fluidic device, and these syringes may be used draw fluid through the channels from upstream reservoirs.

In other embodiments, the flow of fluid from one or more reservoirs may be pneumatic or a gravity feed.

As noted previously, the fluid device comprises a separation channel having at its upstream end a junction, a first channel for supplying a first fluid flow, one or two second channels for supplying a second fluid flow, where the first and second channel meet at the junction, wherein the first and second channels are adapted to provide the second fluid flow in the separation channel at least partially containing the first fluid flow, such that the first fluid flow does not contact the separation channel walls disposed along the length of the separation channel. Preferably, the first and second channels are adapted to provide the first fluid flow in the separation channel sheathed by the second fluid flow.

The junction is therefore adapted to permit a suitable flow of the first fluid at least partially contained by the second fluid.

The separation channel may be provided with a head wall at the upstream end of the separation channel. This forms part of the junction for the introduction of the first fluid flow into the second fluid flow. The head wall may have an outlet, or orifice, for supply of the first fluid from the first channel for contacting fluid supplied to the junction from the one or more second channels. The outlet is provided at a location of the headwall such that the supply of the first fluid does not contact the separation channel walls disposed along its length.

The outlet in the head wall is preferably off set from the sides of the head wall, as this will allow the first fluid flow that exits the opening to be provided off set from the separation channel walls that are disposed along it length.

The outlet may have a substantially quadrilateral cross-section, such as rectangular or square cross-section, and such allows for the supply of a first fluid flow having a similar cross-section.

The junction of the fluidic device has an arrangement of the first fluid channel and the second channel that permit the introduction of the second fluid flow non-parallel to the first fluid flow at the junction. Thus, the second channel or channels may be angled into the first fluid channel.

The depth of the separation channel may be selected so as to minimise or eliminate loading problems and high fluid resistance that are associated with very shallow channels (ibid.).

In some prior art references the height or depth of the channel is referred to as the width, w.

Devices for use in the electrophoresis of a component across fluid flows are well known in the art, and are described, for example, by Herling et al. (Applied Physics Letters 102, 184102-4 (2013)). Thus, the separation channel may be provided with electrodes alongside the channel length for deflecting (distributing) charged components across the channel. This is distinguishable from the devices described by the Ramsey group, where electrodes are placed at the channel ends, in order to distribute components along the channel length.

The separation channel is a channel having suitable dimensions allowing for the generation of a stable fluid flow and for achieving an adequate separation of components across the flow.

The separation channel is the region where the first fluid flow is brought into contact with the second fluid flow.

A reference to a separation channel herein is a reference to a channel having a substantially rectangular cross section. Thus, the separation channel may be formed of a substantially flat base with walls which extend substantially vertically therefrom, and optionally a top cover. Typically, the base and the walls are formed into a silicone substrate. The cover may be a glass cover, for example a standard glass slide or a borosilicate wafer. The cover may also be a silicone substrate that is adhered to the base

Typically, other channels within the device, such as the flow separator, are also substantially rectangular.

The separation channel is in fluid communication with one or more reservoirs for the supply of first fluid. The separation channel is in fluid communication with one or more reservoirs for the supply of second fluid.

Typically the flow apparatus comprises a first supply channel and a second supply channel, which channels are in fluid communication with the downstream separation channel. The first supply channel is for holding the first fluid flow and the second supply channel is for providing the second fluid flow. The first and second supply channels meet at a junction with the downstream separation channel, which is adapted to hold the first and second fluid flows in a laminar flow. The channels provide fluid communication between the reservoirs and the separation channel.

In one embodiment, the separation channel comprises a first large cross section channel and a second small cross section channel that is downstream and in fluid communication with the large cross section channel.

The present inventors have found that the use of a large cross section channel at the junction where the first and second fluids first contact minimises fluid stagnation. Such channels are described in WO 2014/064438.

The flow of fluids is along the longitudinal axis of the separation channel. A component may move from the first flow into the second flow, such as the deflection of the component or components, and this movement is transverse to the longitudinal axis of flow, across the width of the channel. In the methods of the invention the movement of component across the height of the channel is minimised.

In one embodiment, the flow apparatus includes a flow separator downstream from and in fluid communication with the separation channel. The flow separator is a channel that is located across a part of the separation channel to collect a part of the contacting first and second fluid flows, and in particular to collect a part the fluid flow containing the component. The location and the width of the channel are selected depending upon the part of the flow that is to be collected and the proportion of the flow that is to be collected.

The flow separator is provided to collect a lateral portion of the fluid flows, and most particularly to collect a lateral portion comprising the component. The flow separator is normally provided across a part of the width of the separation channel at a downstream end, and this part is typically spaced away from the walls of the separation channel. Thus, the flow separator is not normally intended to collect components in the fluid flows that have contacted the walls of the separation channel.

The flow separator diverts a part of the flow from the separation channel. The flow separator may provide the diverted flow to, and may be in fluid communication with, a downstream detection zone.

In a preferred embodiment, the flow separator is located across a part of the width of the channel and optionally a part of the height of the channel. The flow separator may be an orifice in a downstream head wall of the separation channel. This orifice is laterally offset with respect to the first fluid flow, as this flow is provided at the junction of the upstream end of the separation channel. The flow separator is intended to collect a component from that has undergone a deflection in the separation channel under the influence of an applied field. Thus, the flow separator should by necessity be offset with respect to the first fluid flow to account for the lateral movement of the component from the first fluid flow.

In a preferred embodiment, the flow separator is located across a part of the height of the channel. Here, the flow separator is intended to collect those components that have not vertically diffused in the separation channel. Thus, the flow separator may be used to collect those components that have substantially retained their vertical distribution throughout their passage downstream in the separation channel.

Here, a reference to vertical movement and vertical distribution is a reference to movement and distribution that is substantially perpendicular to the force applied in the separation channel for phoresis. Typically this movement and vertical distribution is also substantially perpendicular to the flow direction in the separation channel.

The detection zone comprises a detection fluid channel for holding the fluid flow from the upstream flow separator. The detection zone may comprise the analytical device for analysing component that is held in the detection fluid channel.

In one embodiment, the detection fluid channel is in communication with one or more upstream flow supply channels, which fluid channels are downstream of the flow separator. The flow supply channels are for supplying label and denaturing reagent into the detection fluid channel. Each of the supply channels may be in communication with an upstream reservoir for holding the relevant agents such as label and denaturing reagent.

As described herein, label and denaturing reagent may be provided together in one fluid flow. Thus, a single supply channel may be provided upstream of the detection channel. The supply channel contacts the detection channel at a junction.

As described herein, label and denaturing reagent may be provided in separate fluid flows. Thus, a first supply channel may be provided for delivery of denaturing reagent into the detection channel. A second supply channel may be provided for delivery of label into the detection channel. The first and second supply channel contact the detection channel at first and second junctions respectively. The first junction is located upstream of the second junction.

Where the diverted flow is permitted to mix with a label flow and/or a denaturing flow in the detection channel, the detection channel may be provided with a mixing zone to ensure adequate mixing of component in the diverted flow with the label and/or denaturing reagent. The mixing zone may simply refer to an elongation of the detection channel that provides sufficient flow residency time for the fluids to allow for mixing and reaction of the component. The mixing zone may have a non-linear path to enhance mixing. The use of such channel architectures is well known to those of skill in the art.

The analytical device is not particularly limited and includes those device that are suitable for use with flow apparatus, and particularly microfluidic devices. A plurality of analytical devices may be provided to determine different physical and chemical characteristics of the component. The analytical devices may be arranged sequentially or in parallel.

The analytical device may be selected in combination with a component label in mind, or the inherent spectroscopic properties of the component in mind. In one embodiment, the analytical device is a fluorimeter. In one embodiment, the analytical device is a dry mass measuring device, such as a quartz crystal microbalance. The methods and devices of the present invention may be used together with the dry mass methods and apparatus of GB 1320127.2.

In one embodiment, the device comprises a reservoir for collecting the flow output from the analytical zone. In one embodiment, the device comprises a reservoir for collecting the non-diverted flow from the separation channel. The flow output from the analytical zone and the non-diverted flow from the separation channel may be collected together in a reservoir. Components in the reservoir may be collected for further use and analysis.

The device of the invention allows fluids to flow through a separation channel, a flow separator and a detection zone. The establishment of flow through a fluidic device, such as a microfluidic device, is well known to those of skill in the art. For example, the fluid flows may be provided by syringe pumps that are the reservoirs for the various fluid channels. Alternatively, fluid flow may be established by gravity feed of fluids into the device. In another alternative, fluid flow may be established by drawing liquids through the device from the fluid exits in the device, for example using a syringe pump.

In one embodiment, the diverted flow, typically containing the component, optionally together with other components, may be subjected to a further separation procedure for example to at least partially further purify the component from the other components. One of the present inventors has previously described, in WO 2015/071683, a flow system where a diverted flow is subjected to a further separation technique for enhanced purification and analysis. Such a system may be adapted for use in the methods and apparatus of the present invention.

A diverted flow may be used as a first fluid flow in a method of the invention. Thus, a method of the invention may be repeated, for example using a different phoresis technique, also for enhanced purification and analysis.

A device of the invention may incorporate or use one or more of these different flow systems.

The devices of the invention may be prepared in part using standard photolithographic techniques, such as described herein. Typically the devices of the invention are prepared from PDMS. Alternatively, the devices may be prepared from plastics by injection moulding or hot embossing, or from glass by chemical etching.

The methods of preparation may allow the fluidic device to be prepared as a unitary piece. Thus, the separation channel and the first and second fluid channels may be part of the same monolithic piece. Such devices may be easy to prepare compared to multicomponent fluidic devices, which will require assembly prior to use, and such may be difficult where close alignment of channels between pieces is required.

The use of photolithography, injection moulding, hot embossing and etching techniques allows for reproducible production of fluidic devices. Each device may be prepared with high precision and uniformity, with little variation between devices.

A device of the invention may be assembled from two or more, such as two, parts, such as layers, which parts may be bonded together. Each part may be prepared by standard photolithographic techniques, and then the parts may subsequently be assembled together. Again, it is typical for each part to be prepared from PDMS, and these may be bonded together, for example under a water and heat treatment, as is known in the art (as also described in the worked examples of the present case). Where a fluid device has a plurality of parts, the parts may be of the same material, such as PDMS or a thermoplastic.

The apparatus may also comprise a diversion channel located at the downstream end of the separation channel. The diversion channel may be provided to divert a part of the lateral cross-section of the contacting fluid flows in the separation channel, and optionally also a part of the vertical cross-section of the contacting fluid flows.

A fluidic device of the invention may be adapted to include apparatus within the device, for example to aid analysis of components within the channels. Thus, in the worked examples of the present case a viewing window is incorporated into the device to permit optical inspection of the contents of the separation channel.

The channel surfaces of the fluid device may be adapted to prevent components from adhering to the surfaces. Thus, in one embodiment, the channel surfaces limit or prevent absorption of a component onto the surface.

In one embodiment, the channels within the fluidic device are hydrophilic or hydrophobic. The present inventors have found that the use of hydrophilic channel surfaces, particularly in the detection zone, prevent the absorption of hydrophobic components, such as hydrophobic proteins, thereby improving the analysis of components in the device. Similarly, hydrophobic channels may be used to prevent the absorption of hydrophilic components.

In particular the inventors have found that the use of hydrophilic or hydrophobic channel surfaces is beneficial at the stage of labelling and denaturing the component. The amount of insoluble material that is generated in the labelling step is minimised.

Hydrophilic channels may be prepared using techniques familiar to those in the art. For example, where the channels in a device are prepared from PDMS, the material may be plasma treated to render the surfaces hydrophilic. Here, the plasma treatment generates hydrophilic silanol groups on the surface of the channels. Such techniques are described by Tan et al. (Biomicrofluidics 4, 032204 (2010)).

In one embodiment, a channel in the fluidic device, such as a channel in the detection zone, has a hydrophilic or hydrophobic surface.

In one embodiment, a channel in the fluidic device, such as a channel in the detection zone, has hydroxyl groups at its surface. In one embodiment, a channel in the fluidic device, such as a channel in the detection zone, has silanol groups at its surface.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

Exemplary Devices of the Invention

A known device (1) is shown in FIG. 1, where a component-containing fluid flowing in a separation channel (2) is shown. Here, the component-containing fluid is flanked by two second fluid flows (carrier fluid). In the absence of an applied field the component in the first fluid is not deflected whilst flowing downstream. When a field is applied, which in the illustrative device (1) is an applied electrical field across the separation channel (2), the component is deflected into the second fluid, here towards the positive side of the separation channel. Where fluid contacts the separation channel walls disposed along the channel, the component movement in the component-bearing fluid is slowed, leading to a broadening of the component distribution in the contacting fluid flows. The present invention looks to minimise the broadening, for example by limiting or preventing component-bearing fluid from contacting the separation channel walls.

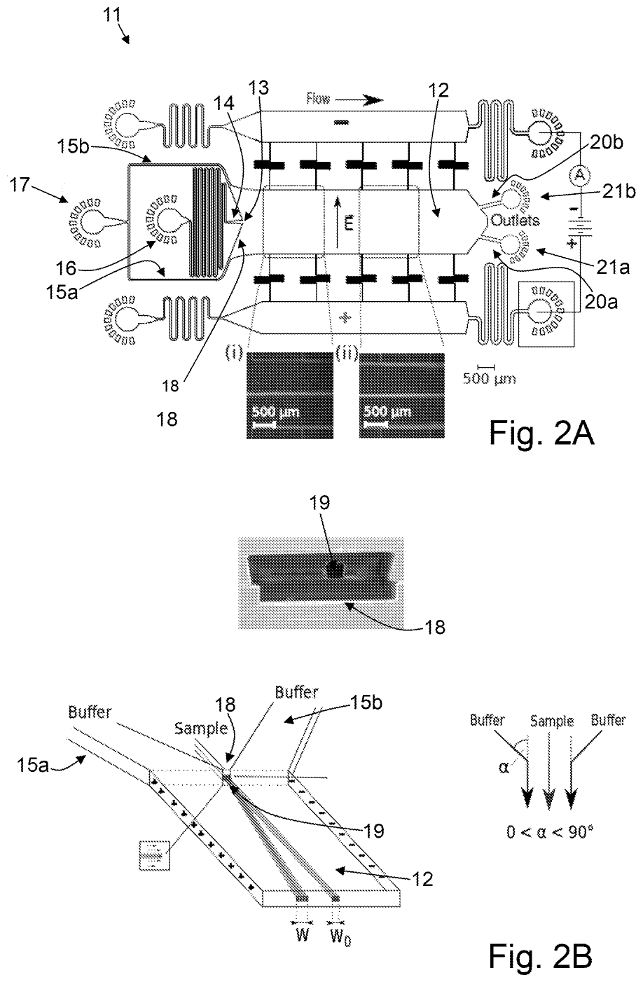

An example device (11) of the invention is shown in FIG. 2(A). Such a device may be used to develop a component fluid flow (also referred as a first flow) in a separation channel (12) that is sheathed by a second fluid flow.

The device (11) is a fluidic device, with the dimensions of the various channels and reservoirs seen from the scale bars given in the FIG. 500 μm).

The fluidic device (11) comprises a separation channel (12) that has a fluid junction (13) at its upstream end. The junction (13) is supplied by a first channel (14) for flow of a first component flow (sample channel) and two second fluid flow channels (15a, 15b) for flow of second fluid flows (flanking buffer). Each channel is supplied by an appropriate fluid reservoir, and the component fluid reservoir (16) is shown together with the communal second fluid reservoir (17). Fluid flows from the reservoirs into the channels, and the component fluid from the first fluid channel (14) is permitted to contact the second fluid flows from the second fluid channels at the junction (13). The flow of fluids in the device may be under the control of syringe pumps that are placed at the upstream or downstream ends of the fluid device. The fluid flows may also be gravity flows.

The arrangement of channels at the junction (13) is such that the second fluid flow sheaths the first fluid flow, and this sheathed flow passes along the separation channel (12) and is subjected to an applied filed, as described in further detail below.

In particular, the junction (13) may be provided with a head wall (18) which has an outlet (19) through which the first component flow may be supplied. This outlet (19) is spaced from the channel walls and is spaced from the channel bottom and top (where a cover is provided over the channels). The outlet (19) may be referred to as an orifice. An example outlet (19) in a head wall (18) is shown in FIG. 2(B). Here, the outlet has a substantially square cross section in the head wall. The outlet is created on joining two PDMS substrates, with at least one substrate having etched channels. Detailed methods for the preparation of the fluidic device are set out in the Experimental and Results section below.

First fluid flowing from the outlet (19), supplied by the first fluid channel (14), is surrounded by second fluid supplied from the second fluid channels (15a, 15b). The sheathed flow is then permitted to flow downstream in the separation channel (12). The present inventors have found that the methods and devices of the invention allow a stable flow of the contacting first and second fluid flows to be rapidly established. Advantageously, it is therefore possible to subject the contacting flows to a phoresis technique soon after the flows contact.

The fluidic device (11) shown in FIG. 2(A) is adapted for electrophoresis channels for holding electrophoretic fluids. Some of the present inventors have previously described methods and apparatus for providing a stable electrical field across a separation channel.

These methods and apparatus are discussed in WO 2017/174975, the contents of which are hereby incorporated by reference. Other methods and apparatus for providing electrophoretic fields across a separation channel are known, and may be used in place of the electrophoretic set-up shown in FIG. 2.

At the downstream end of the separation channel are provided a plurality of diversion channels (20a, 20b) for diverting the fluid flow in the separation channel (12) to collecting outlets (21a, 21b). Here, a diversion channel (20a, 20b) may be provided to collect a lateral portion of the contacting fluid flows containing the component of interest.

In preferred embodiments of the invention, a diversion channel (20a, 20b) may also be provided to collect a vertical portion of the contacting fluid flows.

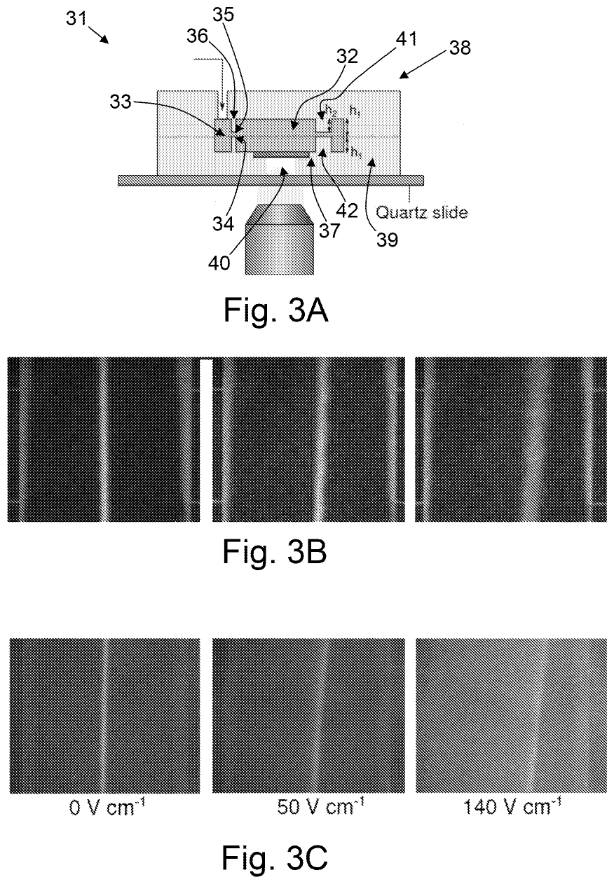

FIG. 3(a) shows a side view cross-section of a fluidic device (31) of the invention along the flow axis of the device.

The fluidic device (31) has a separation channel (fluidic channel) (32) which is supplied by a component fluid flow channel (fluidic inlet/outlet) (33) and two second fluid flow channels (not shown) at a junction (34) at the upstream end of the separation channel (33). The component flow channel (33) is adapted to provide the component fluid flow through an opening, or orifice, (35) in the head wall (36) of the separation channel (32). As shown in the figure, the opening (35) is spaced from the base and top of the separation channel (32). The first fluid flow is delivered into the junction (34) at the upstream end of the separation channel (32), where it is contacted with the second fluid flow. The delivery of the component fluid flow to the junction (34) is such that the first fluid flow is entirely sheathed by (contained within) the second fluid flow.

In the absence of an applied field, the component in the component fluid flow will not significantly deflect from the fluid flow. Any movement of the component in the channel will be diffusional movement of the component, which movement may be lateral and vertical movement of the component of into the second fluid flow.

In this device (31), the separation channel (32) is shown having a quartz slide (37) forming a part of the channel base, to allow for inspection and analysis of the separation channel contents. The fluidic device (31) is prepared from two PDMS substrates (38, 39) that are bonded together, with the channels of the device formed from appropriate recesses (etchings) in each substrate. Additional recesses are also provided for the accommodation of the quartz slide (37) and an observation hole (40)

The presence of the quartz slide (37) and the observation hole is optional, and these may be dispensed with in other embodiments.

The outlet (35) for the component fluid flow into the separation channel (32) is shown, which outlet (35) is spaced from the separation channel (32) base and top. The outlet (35) is for the component flow from the component flow channel (33). This outlet (35) is also spaced from the separation channel walls (not shown). The separation channel is also shown with a downstream diversion channel (39) diverting a part of the fluid flow in the separation channel (32). The separation channel is provided with a foot wall (41) at the downstream end and wall has an outlet (42) for diversion of the part of the fluid flow in the separation channel (32).

Here, the outlet is spaced from the separation channel base and top and is also spaced from the channel side walls that are disposed along the separation channel (not shown).

FIG. 6(b) is schematic showing the separation channel (52) of a fluidic device (51) for use in an electrophoretic method according to an embodiment of the invention. A first fluid flow containing a component in sheathed by a second fluid flow. In the absence of an applied field, the component diffuses from the first fluid flow into the contacting second fluid flow as the contacting fluids flow downstream in the separation channel (52). Thus, the schematic shows the vertical distribution of the component at two downstream locations in the separation channel (52). At the furthest downstream end there is a greater diffusion of the component across the vertical cross-section of the fluid flows.

The application of a field gradient, such as a voltage gradient across the separation channel (52), may cause deflection of the component in the channel (52), and this is shown in the figure, where the first component is laterally-spaced from the flow of the component when no field is applied.

In the preferred methods of the invention, a portion of the contacting fluid flows is collected, which portion is a part of the vertical cross-section of the fluid flows, such as a portion that is spaced from the channel bottom, and also optionally and preferably spaced from the channel top. The part of the vertical cross-section that may be diverted is shown by the horizontal dashed lines in FIG. 6(b).

The diversion of fluid from the separation channel may also be a part of the lateral cross-section of the fluid flows, such as a portion that is spaced from the channel sides. The collection of only a part of the lateral cross-section of the contacting fluid flows also the at least partial separation of the component of interest from other components that have, for example, a greater or lesser deflection in the separation channel. The part of the lateral cross-section that may be diverted is not shown in FIG. 6(b), but it may be envisaged that the portion of the lateral cross-section containing the component of interest will be diverted.

### Experimental and Results

Fabrication of Single Layer Fluidic Devices

Single layer (SL) fluidic devices were fabricated in poly(dimethylsiloxane) (PDMS; Dow Corning) to a height of 50 μm through single, standard soft-lithography steps using SU-8 3050 photoresist on a polished silicon wafer. The channels were sealed with a quartz slide (Alfa Aesar, 76.2×25.4×1.0 mm) after both the PDMS and the quartz surface had been activated with oxygen plasma (Electronic Diener Femto, 40% power for 15 seconds). The quartz-PDMS devices were then exposed to an additional plasma oxidation step (80% power for 500 seconds) to form silanol groups on the PDMS surface and render channel surfaces more hydrophilic to avoid protein samples adhering to the PDMS walls of the device.

Fabrication of Multilayered Fluidic Devices

Three-dimensional (3D) fluidic devices were generated by plasma bonding two individual PDMS chips to each other. One of the two chips was produced from a multilayer (ML) replica mold and converted to a PDMS chip via standard photolithography approaches. The second chip was prepared from a single-layer (SL) replica mold and converted into PDMS chip with the integration of a non-PDMS based observation window (FIG. 3a) as described below.

The mold for the single layer PDMS chips was fabricated to a height of 50 mm analogously to the replica mold for the 2D devices, with the chip including all the structures shown in FIG. 2a, with the exception of the protein inlet and the connecting “bridges”. The fabrication of the multilayer replica mold involved two subsequent UV-lithography steps performed with SU-8 3005 and 3050 to give 5 mm and 50 mm high channels, respectively.

The protein inlet (FIG. 2a) as well as the connecting “bridges” between the electropohresis chamber and the electrolyte channels that featured only on the 5 mm layer. The buffer inlet, the electrophoresis chamber and the electrolyte channels were fabricated on the 50 mm layer identically to how they appeared on the single layer device. Alignment between the two lithography processes was achieved through a custom-built mask aligner including an xyz and a rotating stage (ThorLabs, MBT602/M and PROM).

To integrate non-PDMS based observation windows with the SL PDMS devices, small pieces of quartz (ca. 5 mm×5 mm) cut out from a 1 mm thick quartz slide (Alfa Aesar) were placed on top of the SU-8 structures of the replica mold in the areas where the imaging was due to take place. The quartz pieces were carefully pressed against the SU8 structures not to destroy the master mold but to ensure that as little PDMS as possible remained between the quartz and the PDMS. The PDMS was then cured by heating it at 65° C. for 2 hours-longer baking times were found to cause strong adhesion of the quartz to the SU8 structures. The PDMS doped with quartz was then carefully peeled off from the SU8-mold and bonded to its corresponding SL chip to generate a 3D device (FIG. 2b, inset). Inlets for fluidic interacting were introduced only into the ML that was facing upwards while imaging (FIG. 3a) but not to the SL quartz-doped chip. To achieve an alignment accuracy of the order of micrometers between the chips, drops of water were sprayed onto the two plasma activated chips before they were aligned under a stereomicroscope (4.5× magnification) and then placed in an oven at 65° C. for one hour to allow evaporation of the water and the covalent bonding to take place as described earlier (see Saar et al.). Similarly to the 2D devices, the 3D PDMS-PDMS chips were then exposed to an additional plasma oxidation step (80% power for 500 seconds) to render more hydrophilic channel surfaces.

Optical Detection

The movement of bovine serum albumin (BSA) molecules in the device separation channels was visualised using an inverted deep-UV fluorescence microscope. Briefly, the sample was illuminated using a 30 mW 280 nm LED (Thorlabs) exploiting the intrinsic fluorescence of aromatic residues of proteins in the deep-UV wavelength range. The light was passed through an aspherical lens of a focal length of 20 mm to get a nearly collimated beam and after this onto a dichroic filter cube (280/20-25 nm excitation, 357/44-25 nm emission, 310 nm dichroic beamsplitter). The reflected light from the dichroic mirror was focused onto the sample by an infinity corrected UV objective lens (Thorlabs LMU-10X-UVB; numerical aperture of NA=0.25) and the emitted light collected through the same objective, passed through the emission filter and focused onto an EMCCD camera (Rolera EM-C2). All the optics used were made from fused silica to enable high transmission in the UV wavelength region.

Integration of Electric Fields

To integrate electric fields with fluidic channels the present inventors have previously designed a device architecture where the electric potential was applied outside and downstream of the fluidic device and the field propagated back to the chip via the use of a co-flowing highly conductive electrolyte solution. While the narrow fluidic “bridges” between the electrolyte channels and the separation chamber (FIG. 2a) allowed the propagation of the electric field to the separation region of the device, they simultaneously provided a high hydrodynamic resistance to prevent the electrolyte from filling the full separation area but instead it gradually leaked into the separation chamber and generated a stable conductive sheet on the edge of the chamber acting as an electrode (see WO 2017/174975). This approach ensures that all the generated electrolysis products, including Joule heat and gaseous products, are flowed away from the chip by the flowing electrolyte without coming into contact with the analytes. Such fabrication process where all the structures, including the electrodes, were defined lithographically allowed producing the devices in a simple yet highly reproducible manner.

Comparison of the Broadening Effect in 2D and 3D Devices

2D and 3D fluidic channels were fabricated as described above with the 3D device including an observation window fabricated directly into the PDMS (FIG. 3a) in order to enhance the signal sensitivity—PDMS is autofluorescent at the deep-UV wavelengths used in this study which causes strong background fluorescence when he imaging takes place through PDMS chips. An observation hole specifically integrated with the part of the chip which was used for sample visualisation and analysis was found to circumvent this problem and lead to high signal to noise ratios even in 3D chips.

The movement of BSA molecules in an electric field was studied in a conventional single-layer fluidic chip (hereafter referred to as 2D chip) and a hybrid PDMS-PDMS bonded double-layer chip (hereafter referred to as 3D chip) and analysed the width of the analyte beam for a comparable starting width. The profiles at different voltages are shown in FIG. 3b.

Bovine serum albumin molecules (BSA; purchased from Sigma Aldrich and used without further purification) were dissolved in 10 mM phosphate buffer pH 7.4 and injected into the device via the sample inlet (FIG. 2a). The sample and the buffer were injected at 20 and 380 mL h⁻¹ to the 2D devices and 5 and 1,000 mL h⁻¹ to yield similar profiles at 0 Vcm⁻¹ where the beam width is determined by the original sample with and any diffusive broadening that occurs. A voltage ramp from 0 to 60 V was applied across the devices and the deflection of the BSA molecules recorded by an in-house inverted UV-microscope for both chips (FIG. 3b,c). The field strength was determined using a calibration strategy as described earlier where an independent estimate was obtained for the resistances of the electrodes by filling the electrophoretic chamber with a highly conductive fluid.

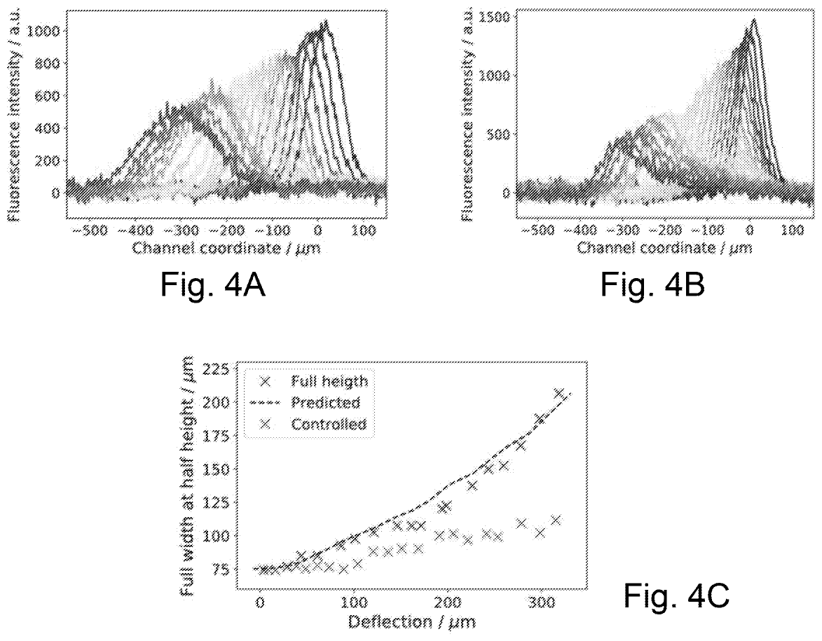

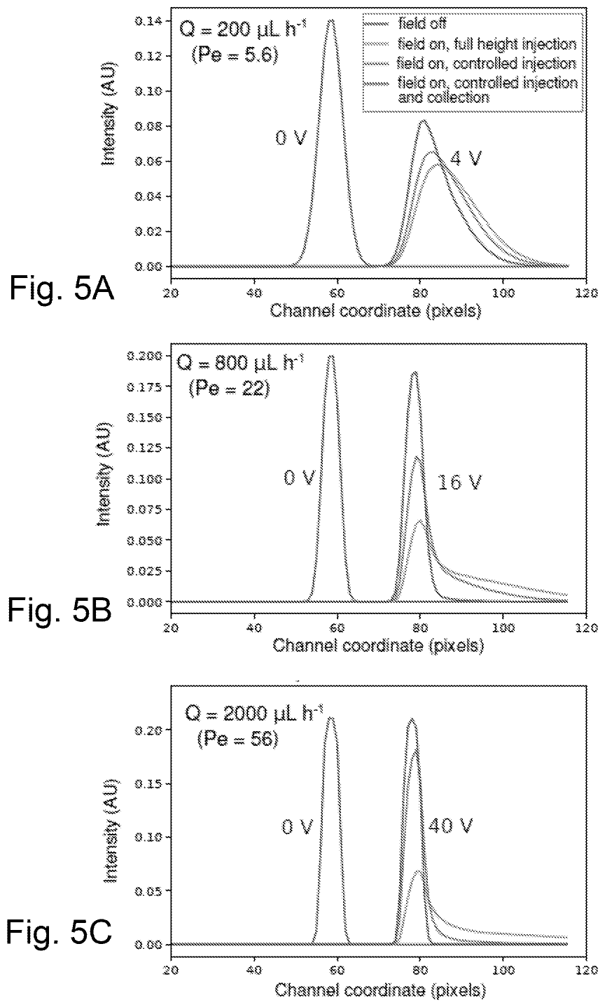

The profiles at different field strength are shown in FIGS. 4 (a) and (b) for the 2D and the 3D devices. To quantify the results, the half-width of analyte beam at its the full-height was used as the parameter to describe the broadening effect. The broadening (defined as the difference in the half-width at a specific voltage and at 0 V) was found to be around four times smaller for the devices with non-restricted injection (FIG. 4c; 150 μm vs. 35 μm) at the maximum deformation studied. We further note that it is possible to reduce the initial width of the analyte beam by adjusting the relative flow rates of the sample solution and the carrier fluid. By doing so, the width of the original beam can be reduced to very small values and in these cases, it is only the broadening extent which determines the effective resolutions and plate numbers of the separation process. This opens up the possibility to use fluidic free-flow electrophoresis for both, resolving a large number of components from one another and resolving mixtures which include components with very similar electrophoretic mobility values. The strategy of controlling sample injection only to areas where the distributions in the velocity gradients are the smallest can be used to similarly increase the achievable resolutions of separation approaches using strategies other than electric field for the separation, such as magnetic or diffusive or thermal fields.

Modelling the Particle Behaviour in 2D and 3D Devices

The movement of the particles in the micron scale channels both while they are injected over the full height of the device and while their injection was restricted to central regions was simulated using custom C++ coding. All the simulation were carried out with N=10⁶ molecules and reflective boundary conditions at the walls.

In order to model the movement of particles in fluidic channels the following equations were used to simulate the movement of the kth particle in a rectangular cross section channel:

xₖ⁽ⁱ⁺¹⁾=xₖ⁽ⁱ⁾+vₓ(yₖ⁽ⁱ⁾,zₖ⁽ⁱ⁾)·Δt+\sqrt{2DΔt}·Random{−1,+1} (1)

yₖ⁽ⁱ⁺¹⁾=yₖ⁽ⁱ⁾+\sqrt{2DΔt}·Random{−1,+1}+μ·E·Δt (2)

zₖ⁽ⁱ⁺¹⁾=xₖ⁽ⁱ⁾+\sqrt{2DΔt}·Random{−1,+1} (3)

where the x-axis is in the direction of the separation channel length, y-axis is in the direction of the separation channel width, z-axis is the separation channel height, and vₓ is the advective flux velocity in x-direction, Δt is the time internal for the simulations, D is the diffusion coefficient of the analyte, μ is electrophoretic mobility and E the strength of the electric field in the channel (see Müller et al.). In order to predict the profiles at a specific position along the channel, the particle movement was simulated up until to the point of interest along the channel length, and the distributions along the y-axis plot by either averaging the particle distributions along the full height of the channel (full collection) or only along a section of interest (central collection).

In particular, the behaviour of a representative protein molecule was modelled. The representative protein was a molecule having a diffusion coefficient of D=7×10⁻¹¹ m² s⁻¹ (hydrodynamic radius of Rₕ=3.0 nm) and electrophoretic mobility of μ=2×10⁻⁸ m² s⁻¹ V⁻¹ (typical of a protein of pl 4.5 to 5 under physiological conditions). The behaviour was modelled in a separation channel that was 50 μm in height, 1,400 μm in width and 5,000 μm in length, with flow rates of 200, 800 and 2,000 μL h⁻¹. These conditions correspond to Péclet numbers of Pe=5.6, Pe=22, and Pe=56 respectively.

For the 3D device, the injection of the component flow was made at the central point of the channel, and the component flow was restricted such it occupied 5% of the width and 5% of the height of the combined flow in the separation channel.

The simulation results are shown in FIG. 3 for each of the different flow rates, where (i) is for a combined flow rate of 200 μL h⁻¹, (ii) for and (iii) for with no electric field applied (blue) and with field applied while the sample had been injected over the full height of the device (orange), into the central 5% along the height (green) and when the centrally injected sample is further collected only at the central 5% (red). The applied voltage was kept indirectly proportional to flow rate to ensure identical deflection within the electric field for the different conditions analysed.

For small Péclet numbers the differences in the observed profiles are small. Indeed, under these conditions the time scale for the diffusional movement along the height of the device is comparable to that of the advective movement along the channel length, meaning a significant fraction of the centrally injected molecules can move away from the position they were injected to and experience a longer residence time.

In contrast, at high Péclet numbers the diffusive timescale is significantly longer than the advective one and within the analysis time the molecules stay in the central area where they were injected to so that the variation in their residence times remains minimal. By the addition of a central collection strategy it is further ensured that any molecules that diffuse away from the central area and as such deflects further are not collected for further analysis, and the analyte beam remains confined with almost no visible broadening.

Injection Nozzle Inlet

An inlet injection inlet is provided at one end of the first channel. The three-dimensional geometry of the injection nozzle inlet makes it possible to control the cross-sectional profile of the injected fluid stream, which is sheathed by another fluid stream.

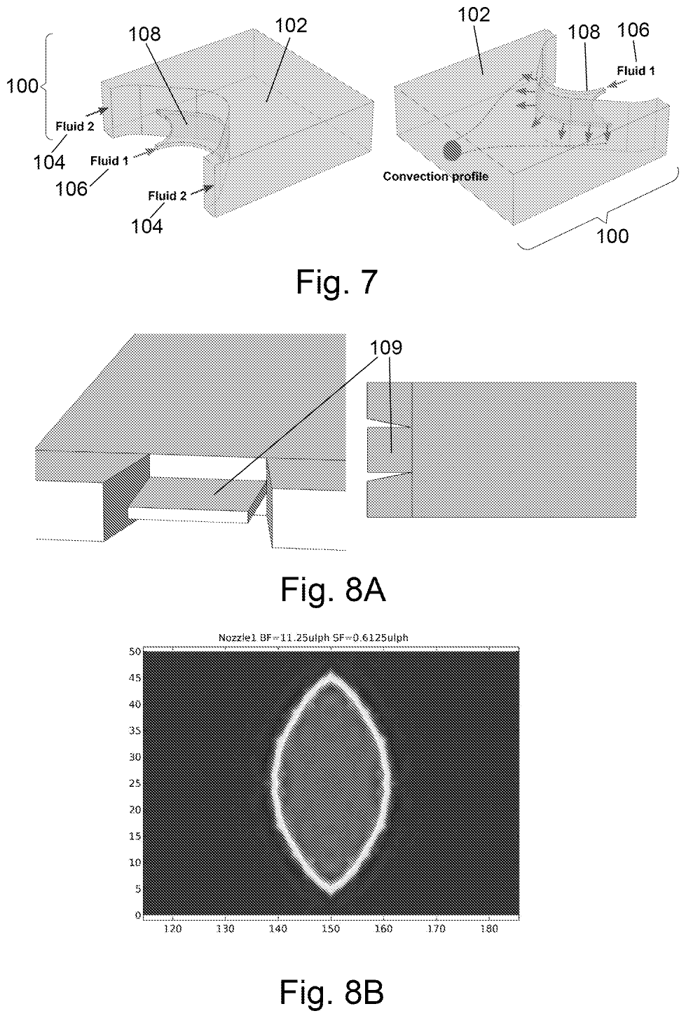

Referring to FIG. 7, there is provided a device 100 comprising a layered main flow chamber 102 of an arbitrary height and width carrying a continuous flow of a second fluid flow i.e. Fluid 2 (F2) 104. A first fluid flow i.e. Fluid 1 (F1) 106, also known as the sample fluid, is injected in the middle of the chamber 107 so that it co-flows continuously with Fluid 2 104 at the injection nozzle 108. The shape of the injection nozzle 108 layer permits the engineering of the cross section of the stream of the first fluid flow 106 in the second fluid flow 104. The injection nozzle inlet 108 has a rectangular, trapezoidal, elliptical, D-shaped cross section but it may possess a specific nozzle contour shape when projected from the top, as shown in FIG. 7. Further examples of injection nozzle inlets not shown in the accompanying drawings may combine two or more of the listed geometries to create a composite geometry. In addition, the geometries of the injection nozzle inlets 108, including the angle of the injection nozzle inlets, may be adjusted accordingly in order to control the cross sectional shape of a fluid profile i.e. Fluid 1 (sample fluid) that has been introduced into the main flow chamber 102. One of the main aims of the injection nozzle 108 is to redistribute Fluid 1 106 such that it does not explore all the vertical height of the main flow chamber 102 and is ideally focused to a circular cross-sectional shape flow. An example of an injection nozzle giving an approximately circular shape Fluid 1 106 convection profile is further described below.

In order to optimise the geometry of the injection nozzle inlet, five different injection nozzle geometries have been created and simulations have been run with the second fluid flow (Fluid 2) and the first flow fluid (Fluid 1) flow rates: F_{B}=11.25 ul/h, F_{S}=0.6125 ul/h. The cross section of the sample inlet can be kept the same (100 μm wide, 10 μm ⅕^{th} of the total device height) but the channel entrance line of the nozzle to the main chamber can be varied. As shown in FIGS. 8 to 12, the injection nozzle inlet may have the following geometries: straight or flat, triangular, elliptical or circular nozzle shapes (top view).

FIGS. 8 (a) and (b) shows the flow profile of the first fluid flow at the end of the device when using the injection nozzle inlet 109 having a flat or straight geometry, as shown in FIG. 8 (a). The first fluid flow profile is focused horizontally and broadened vertically as shown in FIG. 8 (b). The narrow width of the fluid flow profile of the particle or analyte may optimise the resolution of the analyte during analysis. In some instances, selecting the flat or straight geometry of the injection nozzle inlet may be preferable for large particles that show limited diffusion in the separation channel. In addition, a flat or straight geometry of the injection nozzle inlet may also be selected if there are little or no concerns of hydrodynamic broadening of the sheathed fluid flow.

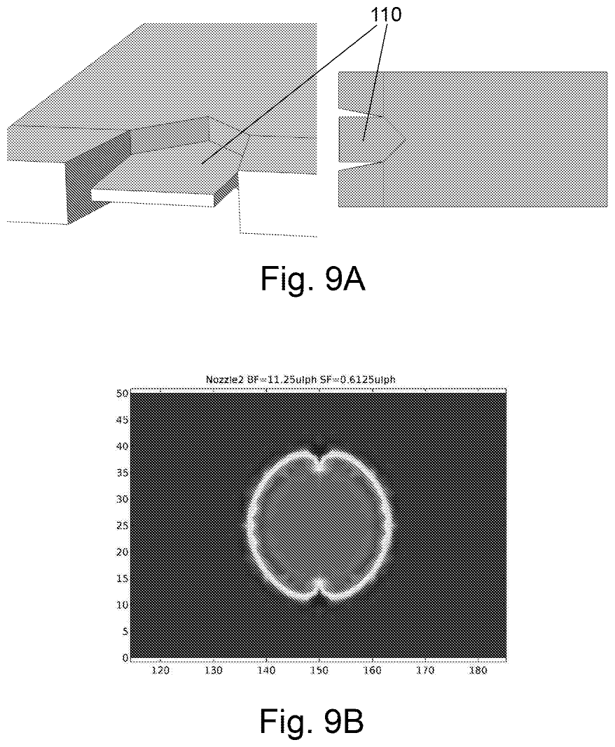

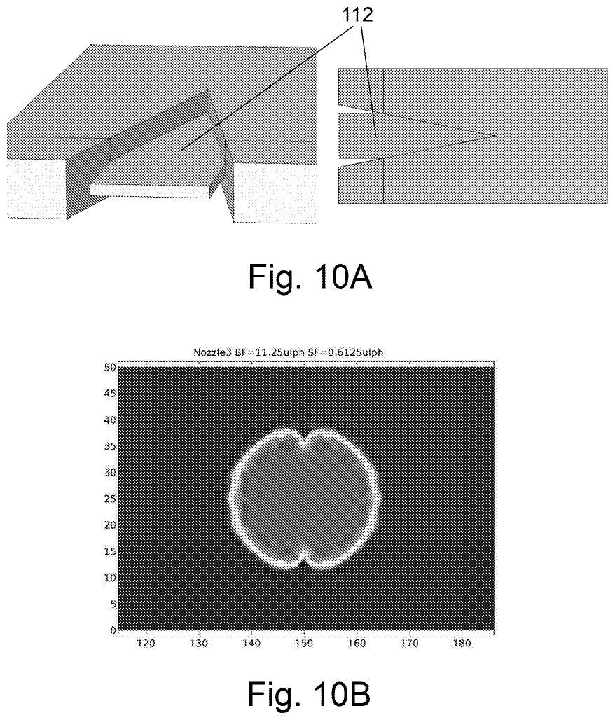

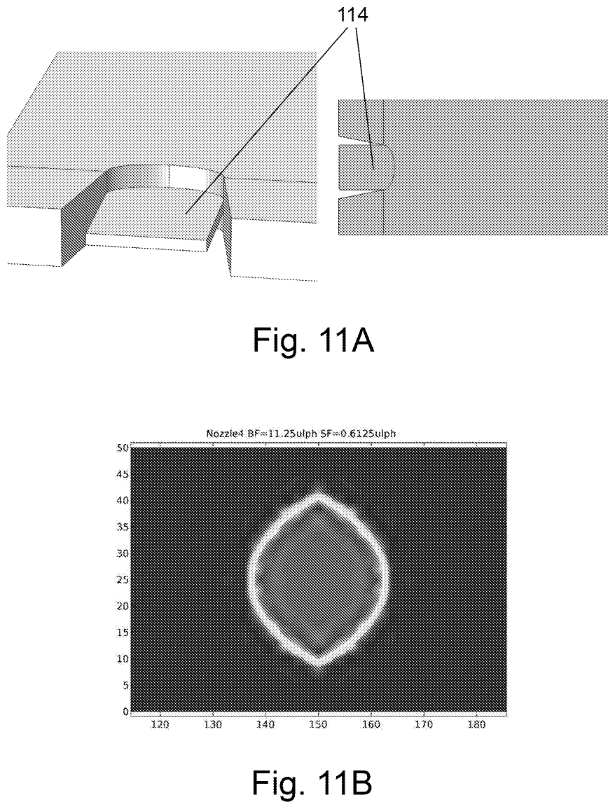

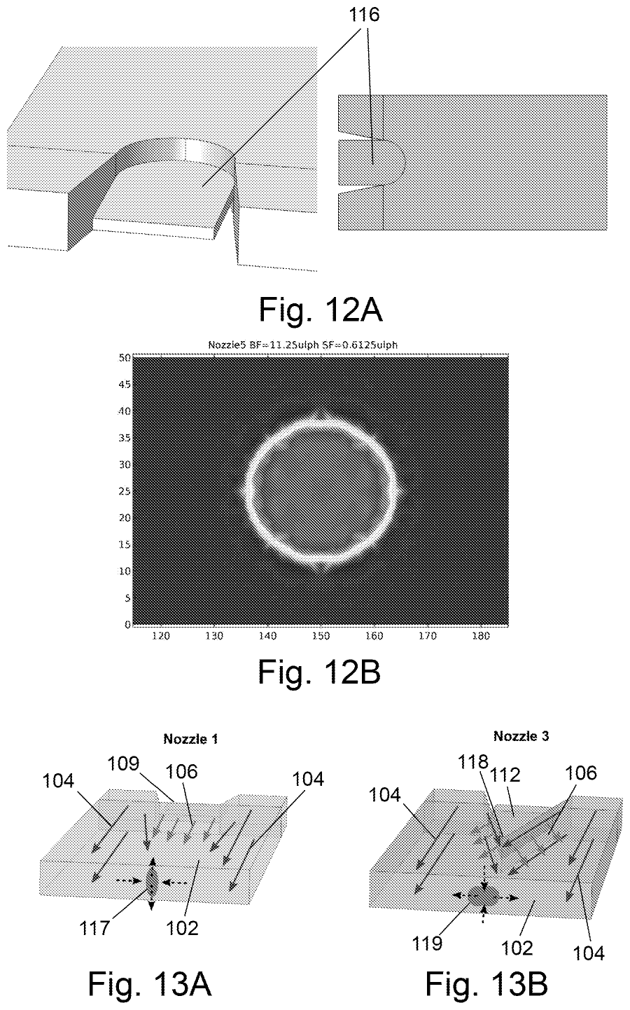

Referring to FIG. 9 (a), the shape of the nozzle entrance is set to a triangular shape 110 with a 45° angle of incidence. The fluid flow profile has a near circular cross section comprising one or more dimples, as shown in FIG. 9 (b). As shown in FIG. 10 (a), the shape of the nozzle entrance can also be set to a triangular shape 112 with an 11.3° angle of incidence. The fluid flow profile has a near circular cross section which may comprise one or more dimples, as shown in FIG. 10 (b), although the overall shape may be accurate, the dimples may be attributed to finite element modelling used to generate these images and may not appear in corresponding experimental data. Referring to FIG. 11 (a), the shape of the nozzle entrance is set to a half-elliptical shape 114 with the major axes 100 μm and 50 μm respectively. The cross section of the fluid flow profile is an oval shape, as shown in FIG. 11 (b). As shown in FIG. 12 (a), the shape of the nozzle entrance is set to a half circle 116 with a radius of 50 μm. As shown in FIG. 12 (b), the circular cross section of the fluid profile provides a large vertical and horizontal distance away from the walls of the separation chamber. In some instances, the shape of the nozzle entrance is set to a half circle in order to reduce or eliminate the hydrodynamic broadening of the sheathed fluid flow during separation or analysis.

As shown in FIGS. 8 to 12, the equilibrated first fluid flow (Fluid 1) convection profile can be dependent on the injection nozzle geometry. In some instances, the cross section area of the fluid profile may be the same for all geometries of the injection nozzle inlet as shown in FIGS. 8 to 12. Using the straight-line or flat injection nozzle inlet (projecting from the top) as shown in FIG. 8, the beam of the first fluid profile almost reaches the top and the bottom surface of the main chamber. In order to prevent the sample fluid i.e. Fluid 1 from fully exploring the vertical height, the injected sample fluid (Fluid 1) can be forced to flow out horizontally.

In one example, the Fluid 1 is injected in a 3-D nozzle with straight horizontal wall and the flow may have access to zero Fluid 2 flow regions directly above and below the injection nozzle. Therefore, Fluid 1 may occupy these zero velocity regions preferably instead of higher flow central region. In some instances, the Fluid 1 may be forced to flow out more horizontally from the end of the microfluidic device, and the convection profile may become more stretched horizontally rather than vertically.

Referring to FIGS. 13 (a) and (b), there is shown a device 100 with (a) a flat or straight nozzle geometry as shown in FIG. 8 and (b) a triangular nozzle geometry according to FIG. 9.

As shown in FIG. 13 (a), the Fluid 1 106 may be introduced into a chamber 102 in a flat or straight nozzle geometry 109, the Fluid 1 may be forced to narrow horizontally and stretch vertically 117, as indicated by the dotted arrows in FIG. 13 (a), compared to its initial injection nozzle cross-sectional shape. However, if Fluid 1 106 is injected in a triangular nozzle geometry 112, as shown in FIG. 13 (b), having an established flow of Fluid 2 104 directly above and below the injection region 118, the convection cross-sectional area of Fluid 1 is stretched horizontally 119, as indicated by the dotted arrows in FIG. 13 (b). Therefore, by changing the curvature and the shape of the nozzle, it is possible to control the convection profile, i.e. hydrodynamic focusing effect, of Fluid 1.

In some instances, the provision of the injection nozzle inlet with a circular geometry, as shown in FIG. 12, has been shown to provide a circular convection profile of the injected fluid flow, thus optimising the sample profile aspect ratio. The radius of the injected fluid flow can be estimated using the following equation:

$$π {R}^{2} = H W * \frac{{Q}_{S a m p l e}}{{Q}_{Total}}$$

$$R = \sqrt{\frac{H W {Q}_{S a m p l e}}{π {Q}_{Total}}}$$

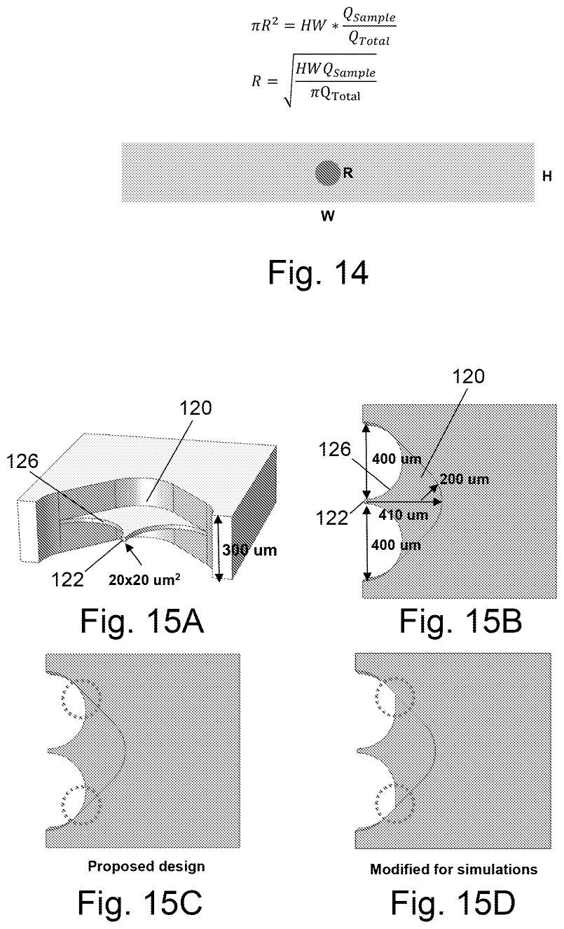

FIG. 14 shows an optimised device design. The sample profile is assumed to be circular where the radius is determined by only the sample to the total flow ratio Q_{S}/Q_{T}. Upon exploring the sample broadening effects, the profile standard deviation describes the width. In 1D, the standard deviation is σ_{1D}²=w²/12 where w is the injection width while in 2D it is σ_{2D}²=R²/18.

Injection Nozzle Design Compatible with Injection Moulding

Injection moulding process may be used to manufacture microfluidic chips, such as chips used for electrophoresis. The mould tool may be milled, and the process to mill the tool may comprise a drill of r=200 μm. Therefore, the minimum radius of curvature of the chip wall is approximately 1/200 μm. The injection nozzle inlet 126 may comprise two layers. The first layer may be between 20 to 200 μm in height having the main electrophoresis chamber 120 and the injection channel 122 as shown in FIGS. 15 (a) and (b). In some embodiments, the first layer may be more than 20, 40, 60, 80, 100, 120, 140, 160 or 180 μm in height. In some embodiments, the first layer may be less than 200, 180, 160, 140, 120, 100, 80, 60 or 40 μm in height. Preferably, the first layer is 60 μm in height.

The injection channel 122 may be between 5 to 40 μm in height or it may be more than 5, 10, 15, 20, 25, 30 or 35 μm in height. In some embodiments, the injection channel may be less than 40, 35, 30, 25, 20, 15 or 10 μm in height. Preferably, the height of the injection channel is 20 μm in height. In some instances, the height of the injection channel is 20 μm in height and may be narrowed down to the height of the injection nozzle inlet of a cross section of 20×20 μm².

The second chamber layer may be between 100 to 200 μm in height or it may be more than 100, 110, 120, 130, 140, 150, 160, 170, 180 or 190 μm in height. In some embodiments, the height of the second chamber may be less than 200, 190, 180, 170, 160, 150, 140, 130, 120 or 110 μm in height. Preferably, the height of the second chamber layer is 40 μm in height. In addition, the second layer height can be adjusted depending on the film stiffness and ease of manufacture.

When combining the first layer and the second layer, the total height of the device may be between 20 to 400 μm, or it may be more than 20, 40, 60, 80, 100, 150, 200, 220, 240, 260, 280, 300, 320, 340, 360 or 380 μm in height. In some embodiments, the total height of the device may be less than 400, 380, 360, 340, 320, 300, 280, 260, 240, 220, 200, 150, 100, 80, 60, 40 25 μm. Preferably, the total height of the device is 100 μm.

Referring to FIG. 15 (c), there is provided a top view of the proposed design. Referring to FIG. 15 (d), there is a shown simulation model of the chip design. To perform Finite Element Method (FEM) simulations, the geometry of the device can be modified slightly so that the geometry of the device does not comprise too many sharp features which may cause meshing problems. In other words, the chip geometry can be modified slightly to capture the main design features but avoid shapes that make simulation complicated.

Flow Profile

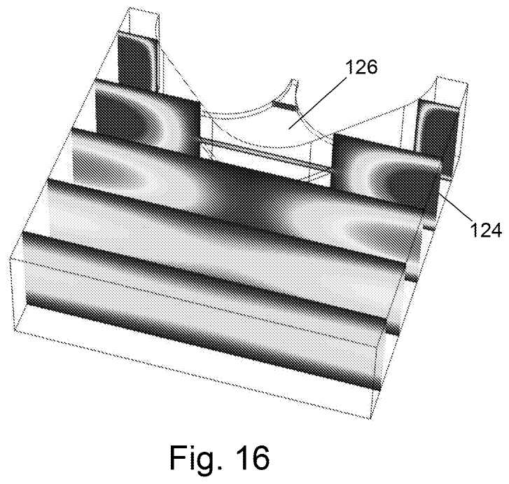

Referring to FIG. 16, there is shown a flow profile within the desired injection nozzle 126 having a circular geometry. A second fluid flow (Fluid 2) containing total buffer flow at Q_{B}=450 μl/h, and the first fluid flow (Fluid 1) is at Qₛ=10 μl/h. The results show a uniform flow profile developing fully in approximately 500 μm distance in a microfluidic (separation) chamber 124.

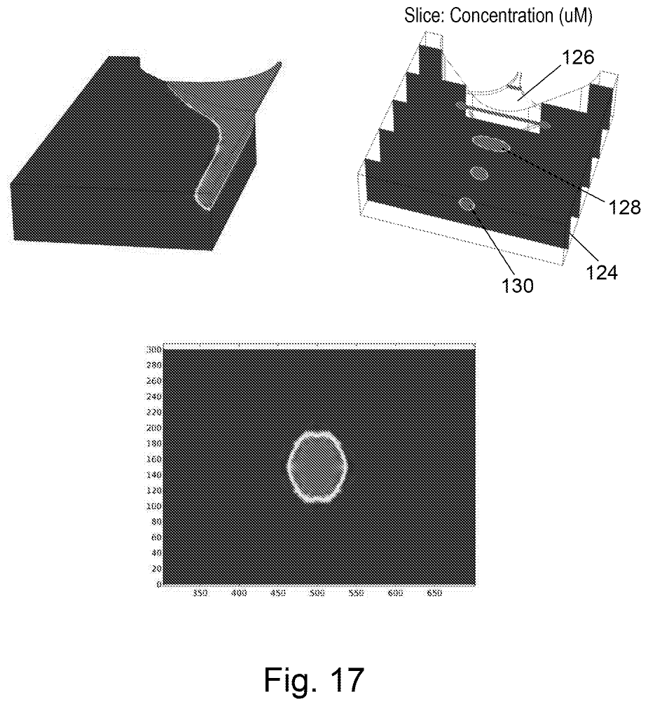

Referring to FIG. 17, there is shown a convection profile of Fluid 1 within the device. The liquid from the sample injection channel may be forced to flow out throughout the whole injection nozzle area 126 which helps the sample 128 to equilibrate approximately at the centre of the separation chamber 124 to form a substantially circular cross section Fluid 1 130 convection profile.

Referring to FIG. 17, there is provided the equilibrated sample injection profile, which can be approximated as a circular cross-section region 130. The co-flow buffer i.e. Fluid 2 flow is at Q_{B}=450 μl/h, the sample fluid i.e. Fluid 1, is at Qₛ=10 μl/h. These simulations can be obtained with the Transport of diluted species module (COMSOL).

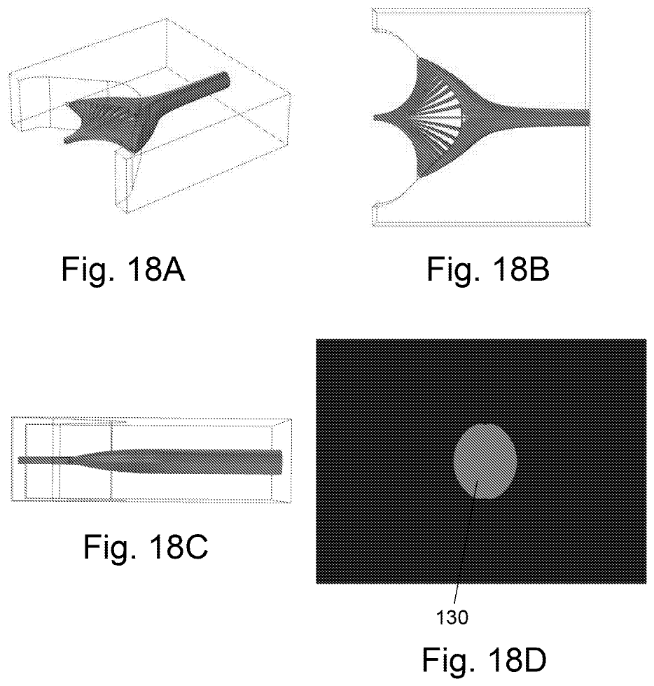

FIG. 18 (a) provides a 3D view of the injection nozzle inlet; FIG. 18 (b) provides a top view of the injection nozzle inlet and FIG. 18 (c) provides a side view of the injection nozzle inlet. The circular cross-section of Fluid 1 130, as shown in FIG. 18 (d), can be achieved with plotting flow streamlines in a very fine manner and setting each of the streamlines to be a tube radius of 1 μm. The plot may provide a smooth shape and moreover, it can provide an insight into the full 3D hydrodynamic focusing of the injected sample fluid.

Misalignment of Layers of the Device

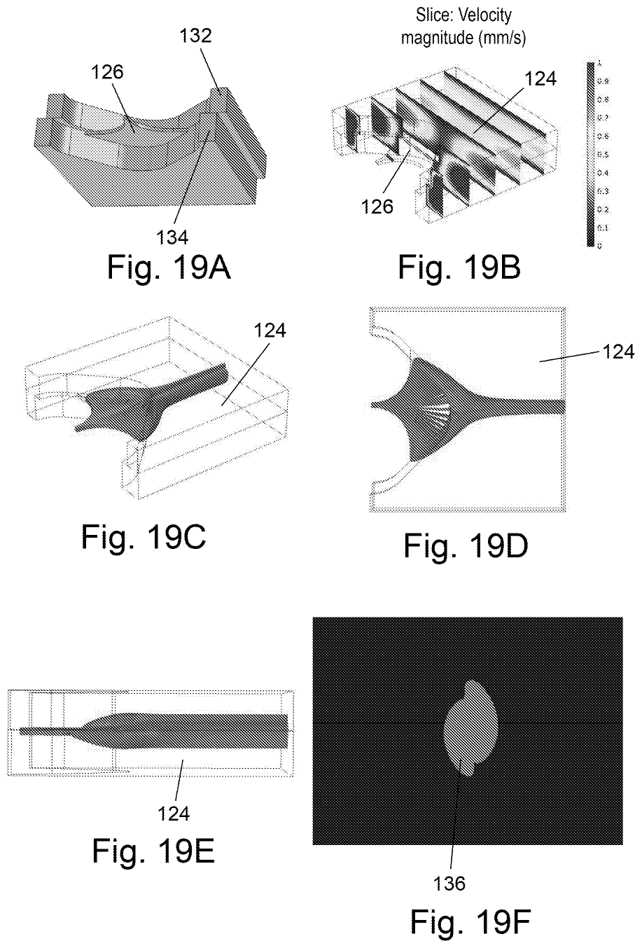

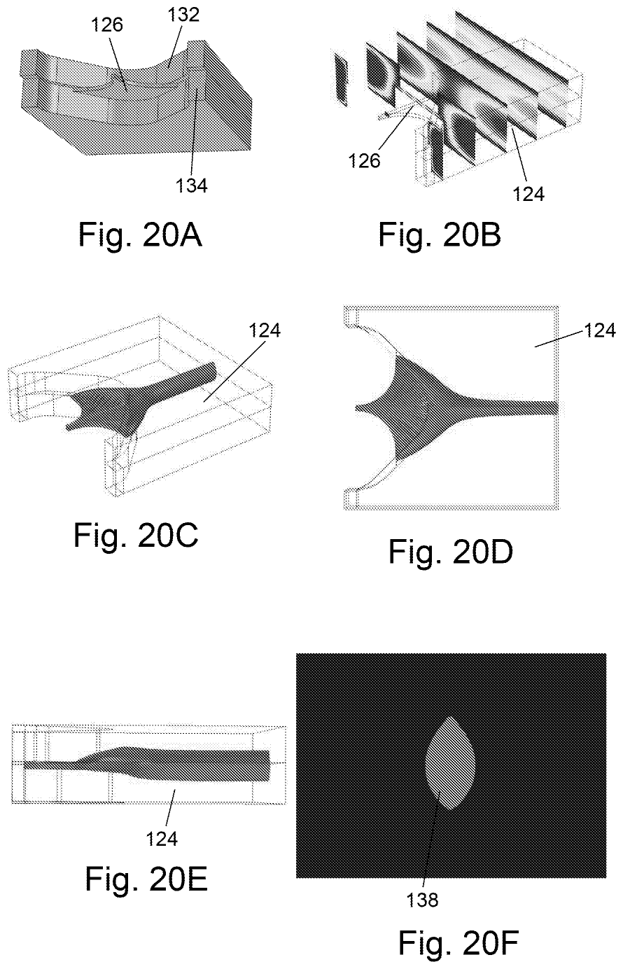

Referring to FIGS. 19 (a), (b), (c), (d), (e) (f) and FIGS. 20 (a), (b), (c), (d), (e) (f), there are provided different points of view of the misaligned fluidic device comprising the main separation chamber or channel, the first channel, the second channel and the nozzle injection inlet. The fabrication of the two-layered device may be complicated and prone to errors. Therefore, in order to stress test the design performance during the fabrication process, the two layers of the device has been misaligned by up to 50 μm across or along the main separation chamber. In some instances, the misalignment of the two layers can exceed 5, 10, 15, 20, 25, 30, 35, 40 or 45 μm. In some instances, the misalignment of the two layers may be less than 50, 45, 40, 35, 30, 25, 20, 15 or 10 μm.

Referring to FIGS. 19 (a), (b), (c), (d), (e) and (f), the misalignment of the layers 132, 134 across (Y axis) the width of the separation chamber 124 causes the sample liquid to leak out through the injection nozzle 126 and form a non-uniform shape sample stream with a high aspect ratio. As shown in FIG. 19 (f), the sample fluid (Fluid 1) has an asymmetrical shape 136 and the cross section of the sample fluid (Fluid 1) is horizontally narrow and vertically stretched.

Referring to FIGS. 20 (a), (b), (c), (d), (e) and (f), there is provided different points of view of the misaligned fluidic device comprising the main separation chamber or channel, the first channel, the second channel and the nozzle injection inlet. The misaligned layers 132, 134 along (x-axis) the separation chamber 124 and the along the (liquid) sample fluid flow direction may cause the sample fluid (Fluid 1) to leak out through the injection nozzle 126 towards the more opened side and produces an effect of an increased sample beam aspect ratio. As shown in FIG. 20 (f), the cross section of the sample fluid (Fluid 1) 138 is horizontally narrow and vertically stretched.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

### REFERENCES

All documents mentioned in this specification are incorporated herein by reference in their entirety.
Müller et al. International Journal of Nonlinear Sciences and Numerical Simulation 2016, 17, 175
Saar et al. Biophysical Journal 2016, 110, 555
Shao et al. Electrophoresis 2012, 33, 2065
Weber and Bocek Electrophoresis 1996, 17, 1906
WO 2014/064438
WO 2015/071683
WO/2017/174975

1. A fluidic device comprising a separation channel having at its upstream end a junction, a first channel for supplying a first fluid flow, a second channel for supplying a second fluid flow, where the first and second channel meet at the junction, wherein the first and second channels are adapted to provide the first fluid flow in the separation channel sheathed by the second fluid flow, such that the first fluid flow does not contact the separation channel walls,
wherein the separation channel, the first and second channels are provided as a unitary piece, or where the separation channel and the first and second channels are provided as a non-unitary piece comprising a plurality of parts, the parts are of the same material; and
wherein the first channel comprises at one of its end an injection nozzle inlet, wherein the injection nozzle inlet has a curved geometry or a triangular geometry or a trapezoidal geometry.

2. (canceled)

3. The fluidic device of claim 1, wherein the curved geometry of the injection nozzle inlet is selected from a group consisting of a semi-circular geometry, a circular geometry, or an elliptical geometry.

4. The fluidic device of claim 3, wherein the cross section of the injection nozzle inlet exceeds the cross section of the first channel.

5. The fluidic device of claim 1, wherein the volume of the separation channel is at most 5,000 mm³.

6. The fluidic device of claim 1, wherein the volume of the separation channel is at most 1,000 mm³.

7. The fluidic device of claim 1, wherein the separation channel has a head wall at the upstream end of the channel at the junction, and the head wall has an outlet through which the first fluid flow is supplied by the first channel, and optionally, the outlet may be provided off centre to the separation channel.

8. The fluidic device of claim 1, wherein the first channel has a substantially quadrilateral cross-section, such as rectangular, trapezoidal or square cross-section.

9. The fluidic device of claim 1, wherein the second channel is adapted to introduce the second fluid flow non-parallel to the first fluid flow at the junction.

10. The fluidic device of claim 1 adapted to allow component phoresis across the separation channel, such as electrophoresis.

11. The fluidic device of claim 1, wherein the fluid device further comprises a flow separator at the downstream end of the separation channel for diversion of a part of the contacting fluid flows.

12. The fluidic device of claim 11, wherein the flow separator is for diversion of a lateral part of the contacting fluid flows, such as for diversion of a lateral part of the contacting fluid flows that is off centre of the separation channel.

13. The fluidic device of claim 11, wherein the flow separator is for diversion of a vertical part of the contacting fluid flows.

14. The fluidic device of claim 11, wherein the flow separator is in fluid communication with a downstream labelling zone for labelling of a component in the diverted flow and/or a downstream detection zone comprising an analytical device for analysis of the diverted flow, such as a device for diffusive sizing, wherein a labelling zone is provided upstream of and in fluid communication with the detection zone and downstream of and in fluid communication with the analysis device.

15. The fluidic device according to claim 1, wherein the fluidic device further comprises a flow separator at the downstream end of the separation channel for diversion of a part of the contacting fluid flows, and the diversion channel is for diversion of a part of the lateral cross-section and/or the vertical cross-section of the contacting fluid flows.

16. The fluidic device according to claim 15, wherein the flow separator is provided off centre at the downstream end of the separation channel.

17-20. (canceled)
